(19) United States
(12) Patent Application Publication
(10) Pub. No.: US 2025/0304448 A1
(43) Pub. Date: Oct. 2, 2025

(54) NANOCARBON COMPOSITE, BOLOMETER USING THE SAME, AND METHOD FOR PRODUCING THEM

(71) Applicant: NEC Corporation, Tokyo (JP)

(72) Inventor: Mayumi KOSAKA, Tokyo (JP)

(73) Assignee: NEC Corporation, Tokyo (JP)

(21) Appl. No.: 19/089,203

(22) Filed: Mar. 25, 2025

(30) Foreign Application Priority Data
Apr. 1, 2024 (JP) 2024-058648

(51) Int. Cl. C01B 32/158; B82Y 30/00; B82Y 40/00; C01B 32/18; G01J 5/20

(52) U.S. Cl. CPC C01B 32/158; B82Y 30/00; B82Y 40/00; C01B 32/18; G01J 5/20; C01B 2202/36; C01B 2204/22; C01P 2004/03; C01P 2004/45; C01P 2004/64; C01P 2006/40

(57) ABSTRACT

One aspect of the present disclosure relates to a nanocarbon composite including (i) a plurality of carbon nanotubes including semiconducting carbon nanotubes in an amount equal to or more than 67% by mass with respect to a total amount of the plurality of carbon nanotubes, and (ii) fibrous carbon nanohorn aggregates adsorbed to the carbon nanotubes, in which the number of the fibrous carbon nanohorn aggregates is equal to or less than one-tenth of the number of the plurality of carbon nanotubes.

This application is based upon and claims the benefit of priority from Japanese patent application No. 2024-058648, filed on Apr. 1, 2024, the disclosure of which is incorporated herein in its entirety by reference.

### TECHNICAL FIELD

The present disclosure relates to a nanocarbon composite, a bolometer using the nanocarbon composite, a method for producing the nanocarbon composite, and a method for producing the bolometer.

### BACKGROUND ART

Infrared sensors have an extremely wide range of applications such as not only monitoring cameras for security, but also thermography for human body, in-vehicle cameras, and inspection of structures, foods, and the like, and are thus actively used in industrial applications in recent years. In particular, development of a low-cost and high-performance uncooled infrared sensor capable of obtaining biological information in cooperation with IoT (Internet of Things) is expected. In conventional uncooled infrared sensors, vanadium oxide (VOₓ) had been mainly used in a bolometer unit, and there are problems that the process is expensive because heat treatment is required under a vacuum and the temperature coefficient resistance (TCR) is low (approximately −2.0%/K).

Since a material having large resistance change in response to temperature changes and high electrical conductivity is required to improve TCR, semiconducting single-walled carbon nanotubes having a large band gap and carrier mobility are expected to be applied to the bolometer unit. Since carbon nanotubes are chemically stable, an inexpensive device manufacturing process, such as printing technology, can be applied, leading to the possibility of manufacturing a low-cost and high-performance infrared sensor.

Since single-walled carbon nanotubes typically include carbon nanotubes with semiconducting properties and carbon nanotubes with metallic properties in a ratio of 2:1, there had been a problem that separation is required to be used for the bolometer unit. PTL 1 (JP 2015-49207 A) discloses that since metallic and semiconducting components are present in a mixed state in single-walled carbon nanotubes, semiconducting single-walled carbon nanotubes of uniform chirality are extracted using an ionic surfactant and applied to a bolometer unit, and TCR of −2.6%/K is thereby achieved.

### CITATION LIST

### Patent Literature

[PTL 1] JP 2015-49207 A

### SUMMARY OF INVENTION

### Technical Problem

However, for practical use of bolometers, not only improvement in TCR but also lower resistance is demanded, and further improvements were thus required. In order to lower the resistance of a bolometer, it is important to bond carbon nanotubes (CNTs) to each other in a film formed by a carbon nanotube network. As a result of SEM observation of a carbon nanotube film (CNT film) prepared by a drop casting method using a CNT dispersion by the inventors, it has been found that a network structure with many gaps is formed as illustrated in FIG. 5A. From a cross-sectional TEM image analysis performed on the CNT film, it was observed that the CNT film was formed of the CNT network including nearly one-layer with many gaps (FIG. 5B).

In view of the above-described problems, an object of one example embodiment of the present invention is to provide a nanocarbon composite constituting a low-resistance bolometer and a method for producing the same.

### Solution to Problem

One aspect of the present disclosure relates to a nanocarbon composite including
a plurality of carbon nanotubes including semiconducting carbon nanotubes in an amount equal to or more than 67% by mass with respect to a total amount of the plurality of carbon nanotubes, and
fibrous carbon nanohorn aggregates adsorbed to the carbon nanotubes, in which
the number of the fibrous carbon nanohorn aggregates is equal to or less than one-tenth of the number of the plurality of carbon nanotubes.

One aspect of the present disclosure relates to a bolometer including
a substrate,
a first electrode disposed on the substrate,
a second electrode disposed on the substrate and spaced from the first electrode, and
a nanocarbon composite film electrically connected to the first electrode and the second electrode, in which
the nanocarbon composite film contains
a plurality of carbon nanotubes including semiconducting carbon nanotubes in an amount equal to or more than 90% by mass with respect to a total amount of the plurality of carbon nanotubes, and
fibrous carbon nanohorn aggregates adsorbed to the carbon nanotubes, and
the number of the fibrous carbon nanohorn aggregates is equal to or less than one-tenth of the number of the plurality of carbon nanotubes.

### Advantageous Effects of Invention

According to one aspect of the present disclosure, it is possible to provide a nanocarbon composite capable of forming a low-resistance bolometer film, a bolometer using the nanocarbon composite, and a method for producing the nanocarbon composite and the bolometer.

### BRIEF DESCRIPTION OF DRAWINGS

FIG. 1 is a schematic view (top view) illustrating a structure of a bolometer according to one example embodiment of the present disclosure;

FIG. 2 is a view schematically illustrating a structure of a nanocarbon composite according to one example embodiment of the present disclosure;

FIG. 3 is a schematic view illustrating aerosol droplets of a dispersion containing fibrous carbon nanohorn aggregates and spherical carbon nanohorn aggregates according to one example embodiment of the present disclosure;

FIG. 4 is an SEM image of a nanocarbon composite in which CNBs adhere to a CNT film prepared in Example 1;

FIG. 5A is an SEM image of carbon nanotubes in a carbon nanotube film prepared by a drop casting method;

FIG. 5B is a cross-sectional TEM image of a carbon nanotube film prepared by a drop casting method; and

FIG. 6 is a schematic view illustrating a structure of a complex of carbon nanotubes and spherical carbon nanohorn aggregates in JP 2012-214342 A.

### EXAMPLE EMBODIMENT

A nanocarbon composite according to one example embodiment of the present disclosure includes:
a plurality of carbon nanotubes including semiconducting carbon nanotubes in an amount equal to or more than 67% by mass with respect to a total amount of the carbon nanotubes, and
fibrous carbon nanohorn aggregates adsorbed to the carbon nanotubes, in which
the number of the fibrous carbon nanohorn aggregates is equal to or less than one-tenth of the number of the carbon nanotubes.

The nanocarbon composite according to one example embodiment of the present disclosure can be used as a variable resistance material whose electric resistance varies with temperature changes, and the nanocarbon composite is preferably used in a bolometer and more preferably used in a bolometer for an infrared sensor. A bolometer according to one example embodiment of the present disclosure includes:
a substrate;
a first electrode disposed on the substrate;
a second electrode disposed on the substrate and spaced from the first electrode; and
a nanocarbon composite film electrically connected to the first electrode and the second electrode, in which
the nanocarbon composite film contains
a plurality of carbon nanotubes including semiconducting carbon nanotubes in an amount equal to or more than 67% by mass (preferably equal to or more than 90% by mass) with respect to a total amount of the carbon nanotubes, and
fibrous carbon nanohorn aggregates adsorbed to the carbon nanotubes, and
the number of the fibrous carbon nanohorn aggregates is equal to or less than one-tenth of the number of the carbon nanotubes.

The inventors have found that in a case where a nanocarbon composite, in which fibrous carbon nanohorn aggregates serving as an electrically conductive additive are adsorbed to carbon nanotubes including semiconducting carbon nanotubes in an amount equal to or more than 67% by mass (preferably equal to or more than 90% by mass), is used for a resistance variable film (film whose electric resistance varies with temperature changes) of a bolometer, the resistance can be remarkably lowered while a favorable TCR is maintained.

In JP 3453377 B2 and JP 2012-214342 A, there is no description of a bolometer, but a composite (complex) of carbon nanotubes and carbon nanohorns. For example, FIG. 6 is a schematic view illustrating a structure of a carbon nanotube/nanohorn complex described in JP 2012-214342 A, and illustrates that a carbon nanotube/nanohorn complex 4 has a structure in which carbon nanohorn aggregates 2 are dispersed between carbon nanotubes 3. However, only spherical carbon nanohorn aggregates (also described as “CNHs”) are contained in the complex described in JP 3453377 B2 and JP 2012-214342 A. As illustrated in FIG. 6, since the CNHs are zero-dimensional conductors, the number of CNTs connected to one CNH is limited. Furthermore, since a current flows between the CNHs by hopping conduction, the effect of imparting electrical conductivity to the connection portion between the CNHs and the CNTs is not large, and there is room for further improvement in use in a bolometer.

In one example embodiment of the present disclosure, it is preferable that the nanocarbon composite forms a film, and it is more preferable that the nanocarbon composite forms an electrical resistance variable film for a bolometer. In the nanocarbon composite of the present disclosure, fibrous carbon nanohorn aggregates (also, described as “carbon nanobrush” or “CNB”) can exist between the networks of the carbon nanotubes. The CNB may be adsorbed onto a surface of a CNT film, or may be adsorbed onto the surface and the inside of the CNT film.

Hereinafter, a nanocarbon composite of the present example embodiment and a bolometer using the nanocarbon composite will be described.

### <Nanocarbon Composite>

A nanocarbon composite of the present disclosure includes a plurality of carbon nanotubes including semiconducting carbon nanotubes, and fibrous carbon nanohorn aggregates (“CNB”) adsorbed to the carbon nanotubes, in which the number of the fibrous carbon nanohorn aggregates is preferably equal to or less than one-tenth of the number of the carbon nanotubes.

In the present disclosure, the term “adsorption” is not limited, and may be, for example, chemical adsorption or physical adsorption. Examples of the physical adsorption include adsorption by van der Waals force. The chemical adsorption means, for example, adsorption that occurs by a force equivalent to the force that causes the formation of a compound, and examples thereof include a covalent bond. In one example embodiment, chemical adsorption may be preferable from the viewpoint of the strength of adsorption.

### (Carbon Nanotube)

The nanocarbon composite of the present disclosure includes a plurality of carbon nanotubes that includes semiconducting carbon nanotubes in an amount equal to or more than 67% by mass with respect to the total amount of the carbon nanotubes. In one example embodiment, it is preferable that the carbon nanotubes form a film. Hereinbelow, there are also sections explaining the case where the carbon nanotubes form a carbon nanotube film, but the present invention is not limited thereto.

As a plurality of carbon nanotubes constituting a nanocarbon composite film, single-walled, double-walled, or multi-walled carbon nanotubes can be used, and it is preferable to use single-walled or multi-walled (for example, double-walled or triple-walled) carbon nanotubes and more preferable to use single-walled carbon nanotubes. The carbon nanotubes preferably include the single-walled carbon nanotubes in an amount equal to or more than 80% by mass, and more preferably equal to or more than 90% by mass (including 100% by mass).

The diameter of a carbon nanotube is preferably between 0.6 to 1.5 nm, more preferably 0.6 nm to 1.2 nm, and still more preferably 0.7 to 1.1 nm from the viewpoint of increasing the band gap and improving the TCR. In one example embodiment, the diameter is particularly preferably equal to or less than 1 nm, in some cases. In a case where the diameter is equal to or more than 0.6 nm, producing the carbon nanotubes is easier. In a case where the diameter is equal to or less than 1.5 nm, the band gap is likely to be maintained within an appropriate range, and a high TCR can be obtained.

In the present specification, the diameter of the carbon nanotube means that, when the observation of carbon nanotubes on a substrate is carried out using an atomic force microscope (AFM) to measure the diameters of the carbon nanotubes at about 50 places, the carbon nanotubes in an amount equal to or more than 60%, preferably equal to or more than 70%, optionally preferably equal to or more than 80%, and more preferably 100% have diameters within a range of 0.6 to 1.5 nm. It is preferable that the carbon nanotubes in an amount equal to or more than 60%, preferably equal to or more than 70%, optionally preferably equal to or more than 80%, and more preferably 100% have diameters within a range of 0.6 to 1.2 nm, and it is still more preferable to have diameters within a range of 0.7 to 1.1 nm. In one example embodiment, the carbon nanotubes in an amount equal to or more than 60%, preferably equal to or more than 70%, optionally preferably equal to or more than 80%, and more preferably 100% have diameters within a range of 0.6 to 1 nm.

The length of the carbon nanotube is more preferably between 100 nm and 5 μm because carbon nanotubes are easily dispersed and have excellent coatability. From the viewpoint of electrical conductivity of the carbon nanotube, the length is preferably equal to or more than 100 nm. In a case where the length is equal to or less than 5 μm, agglomeration on the substrate is easily controlled. The length of the carbon nanotube is more preferably 500 nm to 3 μm, and still more preferably 700 nm to 1.5 μm. In one example embodiment, the length of the carbon nanotube is preferably equal to or more than 100 nm and more preferably equal to or more than 200 nm, and preferably equal to or less than 1.5 μm, more preferably equal to or less than 1.0 μm, and still more preferably equal to or less than 500 nm.

In the present specification, the length of the carbon nanotube means that, when the observation of at least 50 carbon nanotubes is carried out using an atomic force microscope (AFM) and the observed carbon nanotubes are counted to measure the length distribution of the carbon nanotubes, the carbon nanotubes in an amount equal to or more than 60%, preferably equal to or more than 70%, optionally preferably equal to or more than 80%, and more preferably 100% have lengths within a range of 100 nm to 5 μm. It is preferable that the carbon nanotubes in an amount equal to or more than 60%, preferably equal to or more than 70%, optionally preferably equal to or more than 80%, and more preferably 100% have lengths within a range of 100 nm to 3 μm. It is more preferable that the carbon nanotubes in an amount equal to or more than 60%, preferably equal to or more than 70%, optionally preferably equal to or more than 80%, and more preferably 100% have lengths within a range of 100 nm to 1.5 μm (more preferably 100 nm to 1 μm).

In a case where the diameter and length of the carbon nanotube are within the above-described ranges, the effect of semiconducting properties is more pronounced, and a large current value can be obtained. Therefore, in a case where the carbon nanotubes are used for a bolometer-type infrared sensor, a high TCR value is easily obtained.

In a case where the carbon nanotube film is formed, the thickness thereof is not limited, and may be preferably, for example, equal to or more than 1 nm, more preferably equal to or more than 2 nm, equal to or more than 3 nm, or equal to or more than 5 nm, and may be preferably equal to or less than 10 μm, more preferably equal to or less than 1 μm, or equal to or less than 200 nm. In one aspect, the thickness of the carbon nanotube film is preferably 2 nm to 1 μm, and more preferably 5 nm to 200 nm.

In the present example embodiment, the content of semiconducting carbon nanotubes, preferably semiconducting single-walled carbon nanotubes, in the total amount of carbon nanotubes is generally more than 66% by mass, preferably equal to or more than 67% by mass, more preferably equal to or more than 70% by mass, and still more preferably equal to or more than 80% by mass, and particularly preferably equal to or more than 90% by mass, more preferably equal to or more than 95% by mass, and still more preferably equal to or more than 99% by mass (may be 100% by mass).

### (Separation of Semiconducting Carbon Nanotubes)

Since single-walled carbon nanotubes typically include carbon nanotubes with semiconducting properties and carbon nanotubes with metallic properties in a ratio of about 2:1, separation is required. The separation method is not particularly limited. In one example embodiment, the semiconducting carbon nanotubes constituting the nanocarbon composite film can be produced by a method including a step of cutting and dispersing carbon nanotubes using a surfactant (preferably a nonionic surfactant) and a step of separating the carbon nanotubes.

As the carbon nanotubes, carbon nanotubes from which surface functional groups, impurities such as amorphous carbon, a catalyst, and the like are removed by performing heat treatment in a vacuum under an inert atmosphere may be used. The heat treatment temperature can be appropriately selected, but is preferably 800° C. to 2,000° C., and more preferably 800° C. to 1,200° C.

The nonionic surfactant can be appropriately selected, and it is preferable to use one or a combination of a plurality of nonionic surfactants having a hydrophilic site that is not ionized and a hydrophobic site such as an alkyl chain, such as a nonionic surfactant having a polyethylene glycol structure represented by a polyoxyethylene alkyl ether-based compound and an alkyl glucoside-based nonionic surfactant. As such a nonionic surfactant, for example, a polyoxyethylene alkyl ether represented by Formula (1) is suitably used. The alkyl moiety may contain one or more unsaturated bonds.

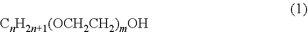

(In formula, n is preferably 12 to 18, and m is 10 to 100 and preferably 20 to 100.)

In particular, it is more preferable to use nonionic surfactants defined by polyoxyethylene (n) alkyl ethers (n is equal to or more than 20 and equal to or less than 100, and the alkyl chain length is equal to or more than C12 and equal to or less than C18) such as polyoxyethylene (23) lauryl ether, polyoxyethylene (20) cetyl ether, polyoxyethylene (20) stearyl ether, polyoxyethylene (10) oleyl ether, polyoxyethylene (10) cetyl ether, polyoxyethylene (10) stearyl ether, polyoxyethylene (20) oleyl ether, and polyoxyethylene (100) stearyl ether. N,N-bis [3-(D-gluconamido)propyl]deoxycholamide, n-dodecyl β-D-maltoside, octyl β-D-glucopyranoside, and digitonin may also be used.

As the nonionic surfactant, it is possible to use polyoxyethylene sorbitan monostearate (molecular formula: C₆₄H₁₂₆O₂₆, trade name: Tween 60, manufactured by Sigma-Aldrich Co. LLC., or the like), polyoxyethylene sorbitan trioleate (molecular formula: C₂₄H₄₄O₆, trade name: Tween 85, manufactured by Sigma-Aldrich Co. LLC., or the like), octylphenol ethoxylate (molecular formula: C₁₄H₂₂O(C₂H₄O)ₙ, n=1 to 10, trade name: Triton X-100, manufactured by Sigma-Aldrich Co. LLC., or the like), polyoxyethylene (40) isooctylphenyl ether (molecular formula: C₈H₁₇C₆H₄O(CH₂CH₂O)₄OH, trade name: Triton X-405, manufactured by Sigma-Aldrich Co. LLC., or the like), poloxamer (molecular Formula: C₅H₁₀O₂, Trade Name: Pluronic, manufactured by Sigma-Aldrich Co. LLC., or the like), polyvinylpyrrolidone (molecular formula: (C₆H₉NO)ₙ, n=5 to 100, manufactured by Sigma-Aldrich Co. LLC., or the like) and the like.

In one example embodiment, the molecular length of the nonionic surfactant is preferably 5 to 100 nm, more preferably 10 to 100 nm, and still more preferably 10 to 50 nm. In a case where the molecular length is equal to or more than 5 nm, particularly equal to or more than 10 nm, the distance between the carbon nanotubes can be appropriately maintained after the dispersion is applied onto an electrode of the bolometer (a region between an electrode 1 and an electrode 2 described later), and agglomeration is easily suppressed. The molecular length is preferably equal to or less than 100 nm from the viewpoint of constructing a network structure.

In one example embodiment, it is preferable to use a nonionic surfactant having a long molecular length as the nonionic surfactant. Such a nonionic surfactant has weak interaction with the carbon nanotubes, and it is easy to remove the dispersion after being applied onto the base material. Therefore, a stable carbon nanotube electrically conductive network can be formed, and an excellent TCR value can be obtained. Since such a nonionic surfactant has a long molecular length, the distance between the carbon nanotubes increases during the application of the dispersion, and re-agglomeration is less likely to occur when electrodes are produced. Therefore, in a case where a carbon nanotube network in an isolated and dispersed state is formed while an appropriate interval is maintained and used for a bolometer, it is possible to achieve a large resistance change in response to temperature changes. For the reasons described above, the bolometer producing method according to the present example embodiment may be suitable for a printing process.

A method for obtaining a dispersion solution is not particularly limited, and a conventionally known method can be applied. For example, a carbon nanotube mixture (including semiconducting-type and metallic-type), a dispersion medium, and a nonionic surfactant are mixed to prepare a solution containing carbon nanotubes, and this solution is subjected to ultrasonic treatment to disperse the carbon nanotubes, thereby preparing a carbon nanotube dispersion (micellar dispersion solution). The dispersion medium is not particularly limited as long as it is a solvent capable of allowing carbon nanotubes to be dispersed and suspended during the separation step, and for example, water, heavy water, an organic solvent, an ionic liquid, a mixture thereof, or the like may be used, and water and heavy water are preferable. In addition to or instead of the ultrasonic treatment, a carbon nanotube dispersion method by mechanical shearing force may be used. The mechanical shearing may be carried out in the gas phase. In the micellar dispersion aqueous solution obtained by mixing the carbon nanotubes and the nonionic surfactant, the carbon nanotubes are preferably in an isolated state. Therefore, bundles, amorphous carbon, impurity catalyst, and the like may be removed by using an ultracentrifugation treatment as necessary. During the dispersion treatment, the carbon nanotubes can be cut, and the length can be controlled by changing conditions for pulverizing the carbon nanotubes, an ultrasonic power, an ultrasonic treatment time, and the like. For example, untreated carbon nanotubes can be pulverized with tweezers, a ball mill, or the like to control the agglomeration size. After these treatments, the length can be controlled to 100 nm to 5 μm by using an ultrasonic homogenizer with an output of 40 to 600 W, optionally 100 to 550 W, 20 to 100 KHz, and a treatment time of 1 to 5 hours, preferably up to 3 hours. In a case where the treatment time is shorter than 1 hour, depending on the conditions, the carbon nanotubes may barely disperse and may remain almost at their original length. The treatment time is preferably equal to or shorter than 3 hours from the viewpoint of shortening the distribution treatment time and cost reduction. The present example embodiment can also have an advantage that adjustment of cutting is easy by using a nonionic surfactant. An infrared sensor according to the present example embodiment produced using the carbon nanotubes prepared by the method using the nonionic surfactant also has an advantage of containing no ionic surfactant that is difficult to be removed.

In one aspect, by dispersing and cutting the carbon nanotubes, surface functional groups are generated on the surfaces or edges of the carbon nanotubes. The generated functional groups include a carboxyl group, a carbonyl group, and a hydroxyl group, and the like. In a case where the treatment is carried out in the liquid phase, a carboxyl group and a hydroxyl group are generated, and in the gas phase, a carbonyl group is generated.

The concentration of the surfactant in the liquid containing heavy water or water and the nonionic surfactant is preferably from the critical micelle concentration to 10% by mass, and more preferably from the critical micelle concentration to 3% by mass. In a case where the concentration is less than the critical micelle concentration, dispersion cannot be achieved, which may be undesirable. In a case where the content is equal to or less than 10% by mass, carbon nanotubes can be applied at a sufficient density after separation, while the amount of the surfactant is reduced. In the present specification, the critical micelle concentration (CMC) refers to a concentration at which a surface tension is measured by varying the concentration of the aqueous surfactant solution using, for example, a surface tensiometer such as a Wilhelmy-type surface tensiometer at a constant temperature, with the concentration determined from the inflection point. In the present specification, the “critical micelle concentration” is a value at 25° C. under atmospheric pressure.

The concentration of the carbon nanotubes (weight of carbon nanotubes/(total weight of dispersion medium and surfactant)×100) in the cutting and dispersing step is not particularly limited, and may be, for example, 0.0003% to 10% by mass, preferably 0.001% to 3% by mass, and more preferably 0.003% to 0.3% by mass.

The dispersion obtained through the above-described cutting and dispersion step may be used as it is in the separation step described later, or steps such as concentration and dilution may be carried out before the separation step.

The carbon nanotubes can be separated by, for example, an electric-field induced layer forming method (ELF method: see, for example, K. Ihara et al. J. Phys. Chem. C. 2011, 115, 22827 to 22832, and JP 5717233 B2, all of which are incorporated herein by reference). An example of a separation method using the ELF method will be described. Carbon nanotubes, preferably single-walled carbon nanotubes, are dispersed in a dispersion medium with a nonionic surfactant, and a dispersion thereof is placed in a vertical separation device, and a voltage is applied to electrodes disposed on the upper and lower side to perform separation by carrier-free electrophoresis. The mechanism of separation can be estimated as follows. In a case where the carbon nanotubes are dispersed with the nonionic surfactant, micelles of semiconducting carbon nanotubes have a negative zeta potential, whereas micelles of metallic carbon nanotubes have an opposite sign (positive) zeta potential (in recent years, it is also considered to have a slightly negative zeta potential or be nearly uncharged). Therefore, in a case where an electric field is applied to the carbon nanotube dispersion, semiconducting carbon nanotube micelles are electrophoresed toward the anode (+) and the metallic carbon nanotube micelles are electrophoresed toward the cathode (−) due to the difference in zeta potential. Ultimately, a layer of concentrated semiconducting carbon nanotubes is formed near the anode, and a layer of concentrated metallic carbon nanotubes is formed near the cathode in the separation tank. The separation voltage may be appropriately set in consideration of the composition of the dispersion medium, the charge amount of the carbon nanotubes, and the like, and is preferably equal to or more than 1 V and equal to or less than 200 V, and more preferably equal to or more than 10 V and equal to or less than 200 V. A voltage equal to or more than 100 V is preferable from the viewpoint of shortening the time of the separation step. The voltage is preferably equal to or less than 200 V from the viewpoint of minimizing the generation of bubbles during separation and maintaining the separation efficiency. Purity is improved by repeating the separation. The dispersion after separation may be reset to the initial concentration and the same separation operation may be performed. As a result, it can be further purified.

A dispersion in which the semiconducting carbon nanotubes having desired diameters and lengths are concentrated can be obtained by the steps of dispersing and cutting, and separating the carbon nanotubes described above. In the present specification, the carbon nanotube dispersion in which the semiconducting carbon nanotubes are concentrated may be referred to as a “semiconducting carbon nanotube dispersion”. The semiconducting carbon nanotube dispersion obtained by the separation step means a dispersion preferably containing semiconducting carbon nanotubes in an amount equal to or more than 67% by mass, more preferably equal to or more than 70% by mass, and in particular, preferably equal to or more than 80% by mass, more preferably equal to or more than 90% by mass, more preferably equal to or more than 95% by mass, still more preferably equal to or more than 99% by mass (the upper limit may be 100% by mass) in the total amount of the carbon nanotubes. The separation tendency of metallic and semiconducting carbon nanotubes can be analyzed by microscopic Raman spectrometry and ultraviolet-visible-near-infrared spectrophotometry.

Centrifugation treatment may be performed to remove bundles, amorphous carbon, metal impurities, and the like from the carbon nanotube dispersion after the steps of dispersing and cutting the carbon nanotubes described above, and before the separation step. The centrifugal acceleration may be appropriately adjusted, but is preferably 10,000× g to 500,000×g, more preferably 50,000×g to 300,000×g, and optionally may be 100,000×g to 300,000×g. The centrifugation time is preferably 0.5 hours to 12 hours, more preferably 1 to 3 hours. The centrifugation temperature may be appropriately adjusted, and is preferably 4° C. to room temperature and more preferably 10° C. to room temperature.

In one example embodiment, it may also be preferable not to perform the ultracentrifugation treatment. In particular, in an example embodiment in which the dispersion containing carbon nanotubes contains a nonionic surfactant, particularly a nonionic surfactant having a large molecular length, since it is easy to suppress bundle formation, there is also an advantage that the number of process steps can be reduced and the cost can be reduced without performing the ultracentrifugation treatment.

### (Fibrous Carbon Nanohorn Aggregate)

Since the nanocarbon composite of the present disclosure contains the fibrous carbon nanohorn aggregates as an electrically conductive additive, it is possible to lower the resistance of the bolometer. A fibrous carbon nanohorn aggregate is referred to as a carbon nanobrush (CNB) and has a structure in which single-walled carbon nanohorns are radially aggregated and connected in a fibrous manner. The fibrous carbon nanohorn aggregate can maintain a fibrous shape even though an operation such as centrifugation or ultrasonic dispersion is performed, unlike a structure in which single-walled carbon nanohorns are simply connected in a series to appear fibrous. The single-walled carbon nanohorn is a cone-shaped carbon structure in which a graphene sheet is rolled up into a structure with a pointed horn-shaped tip with a tip angle of approximately 20°, a diameter of 1 nm to 5 nm, and a length of 30 nm to 100 nm. The carbon structure is a structure mainly containing carbon, and may contain a light element or a catalytic metal. The fibrous carbon nanohorn aggregate is a fibrous carbon structure, and generally has a diameter of 30 nm to 200 nm and a length of 1 μm to 100 μm, for example, 2 μm to 30 μm. The aspect ratio (length/diameter) of the fibrous carbon nanohorn aggregate is generally 4 to 4,000, for example, 5 to 3,500. A surface of the fibrous carbon nanohorn aggregate has protrusions of single-walled carbon nanohorns with a diameter of 1 nm to 5 nm and a length of 30 nm to 100 nm. The fibrous carbon nanohorn aggregate has high electrical conductivity because it has a feature of a structure in which highly electrically conductive single-walled carbon nanohorns are connected in a fibrous manner to form a long electrically conductive path. The fibrous carbon nanohorn aggregate also has high dispersibility, and has a high effect of imparting electrical conductivity.

The fibrous carbon nanohorn aggregate is formed by connecting carbon nanohorn aggregates of the seed type, bud type, dahlia type, petal-dahlia type, and petal type (graphene sheet structure). That is, one or a plurality of types of carbon nanohorn aggregates is contained in the fibrous structure. The seed type has a shape in which little or no horn-shaped protrusions are observed on a surface of an aggregate, the bud type has a shape in which some horn-shaped protrusions are observed on a surface of an aggregate, the dahlia type has a shape in which a large number of horn-shaped protrusions are observed on a surface of an aggregate, and the petal type has a shape in which petal protrusions are observed on a surface of an aggregate. The petal structure is a structure having a width of 50 nm to 200 nm, a thickness of 0.34 nm to 10 nm, and 2 to 30 graphene sheets. The petal-dahlia type is an intermediate structure between the dahlia type and the petal type. The shape and particle diameter of a carbon nanohorn aggregate to be produced vary depending on the type and flow rate of a gas.

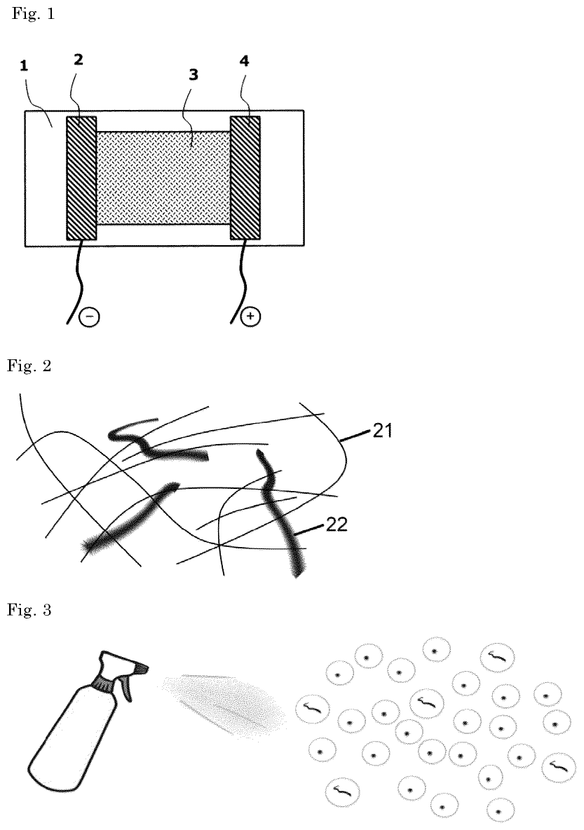

The fibrous carbon nanohorn aggregate is also described in detail in WO 2016/147909 A1. FIG. 1 and FIG. 2 of WO 2016/147909 A1 disclose transmission electron microscope images of the fibrous carbon nanohorn aggregates. In the fibrous carbon nanohorn aggregates illustrated in the transmission electron microscope images, single-walled carbon nanohorns (carbon nanohorn aggregate) that are radially aggregated are connected in a fibrous manner. The entire disclosure of WO 2016/147909 A1 is incorporated herein by reference.

In one example embodiment, the nanocarbon composite may contain spherical carbon nanohorn aggregates in addition to the fibrous carbon nanohorn aggregates. As described later, usually, when the fibrous carbon nanohorn aggregates are produced, spherical carbon nanohorn aggregates are also produced at the same time. In the present specification, a mixture containing the fibrous carbon nanohorn aggregates and the spherical carbon nanohorn aggregates is also referred to as a “carbon nanohorn aggregate mixture”. In one example embodiment, the fibrous carbon nanohorn aggregates are produced by laser ablation of an iron-containing carbon target, and at the same time, spherical carbon nanohorn aggregates (also described as “CNHs”) in an amount equal to or more than 80% by mass, and about 10% to 15% by mass of graphite, and carbon fragments are also generated. The content of the fibrous carbon nanohorn aggregates in the product is about a few percent. In one example embodiment, the carbon nanohorn aggregate mixture is a carbon mixture that is produced when fibrous carbon nanohorn aggregates are produced by a laser ablation method described later or the like. The carbon nanohorn aggregate mixture is preferably a mixture containing, as main components, fibrous carbon nanohorn aggregates and spherical carbon nanohorn aggregates that are obtained by removing graphite and the like from such a carbon mixture.

The fibrous carbon nanohorn aggregates may be subjected to the production of defects, the modification with a functional group, and/or bonding with a compound.

Horn portions of the fibrous carbon nanohorn aggregate and the spherical carbon nanohorn aggregate contain a large number of five-membered rings or seven-membered rings and have high reactivity. In a case where defects occur in these horn portions, or a functional group or compound having high bonding/adhesion properties with respect to a base material or a carbon nanotube adheres to these horn portions, the reactivity is further improved, and the adhesiveness (bonding) to the base material or the carbon nanotube is enhanced. Since the fibrous carbon nanohorn aggregate has a larger ratio and number of horn portions in contact with the base material than the spherical carbon nanohorn aggregate, the effect of enhancing adhesiveness by the introduction of the defects, functional group, compound, and the like is higher. Details will be provided in the description of defect production and functionalization steps and cyclodextrin treatment described later.

### (Production of Fibrous Carbon Nanohorn Aggregates)

The fibrous carbon nanohorn aggregates can be produced by a laser ablation method or the like. In the laser ablation method, the carbon containing a catalyst is used as a target (referred to as a catalyst-containing carbon target), the target is heated by laser ablation in a nitrogen atmosphere, an inert atmosphere, hydrogen, carbon dioxide, or a mixed atmosphere while the target is rotated in a vessel in which the catalyst-containing carbon target is placed, and the target is evaporated. A process of cooling the evaporated carbon and catalyst proceeds to obtain fibrous carbon nanohorn aggregates. In the present invention, a carbon mixture produced by an arc-discharge method or a resistance heating method in addition to the laser ablation method can also be used as the carbon nanohorn aggregate mixture. However, the laser ablation method is more preferable from the viewpoint of continuous production at room temperature and atmospheric pressure.

One aspect of the laser ablation method applied in the present invention includes a method in which a target is irradiated with a laser beam in a pulsed or continuous manner, and when the irradiation intensity is equal to or higher than a threshold value, the target converts energy, resulting in plume formation, and a product is deposited on a substrate provided at downstream of the target or is produced in a space in an apparatus and recovered in a recovery chamber.

For the laser ablation, a CO₂ laser, a YAG laser, an excimer laser, a semiconductor laser, or the like can be used, and a CO₂ laser that allows for easy high-power scaling is most suitable. The CO₂ laser can be used with a power of 1 kW/cm² to 1,000 kW/cm², and can operate in both continuous irradiation and pulse irradiation. The continuous irradiation is more desirable for producing the fibrous carbon nanohorn aggregates. The laser beam is condensed by a ZnSe lens or the like and emitted. It is possible to continuously perform synthesis by rotating the target. Any target rotation speed may be set, and the target rotation speed is particularly preferably 0.1 rpm to 6 rpm. Graphitization can be suppressed in a case where the rotation speed is equal to or more than 0.1 rpm, and an increase in amorphous carbon can be suppressed in a case where the rotation speed is equal to or less than 6 rpm. In this case, the laser power is preferably equal to or more than 15 kW/cm², and is most effectively 30 kW/cm² to 300 kW/cm². In a case where the laser power is equal to or more than 15 kW/cm², the target is appropriately evaporated, and the fibrous carbon nanohorn aggregates are easily produced. In a case where the laser power is equal to or less than 300 kW/cm², an increase in amorphous carbon can be suppressed. The vessel (chamber) can be used at a pressure equal to or less than 13332.2 hPa (10000 Torr), but as the pressure approaches a near-vacuum level, carbon nanotubes are more likely to be produced, and the fibrous carbon nanohorn aggregates are not obtained. The pressure in the vessel (chamber) is preferably 666.61 hPa (500 Torr) to 1266.56 hPa (950 Torr), and more preferably around normal pressure (1013 hPa (1 atm≈760 Torr)), which is appropriate for mass synthesis and cost reduction. The irradiation area can also be controlled by the laser power and the degree of light focusing with a lens, and can be used within a range of 0.005 cm² to 1 cm².

As the catalyst, Fe, Ni, and Co may be used alone or in combination. The concentration of the catalyst may be appropriately selected, and is preferably 0.1% by mass to 10% by mass and more preferably 0.5% by mass to 5% by mass with respect to carbon. In a case where the concentration is equal to or more than 0.1% by mass, the fibrous carbon nanohorn aggregates are reliably produced. In a case where the concentration is equal to or less than 10% by mass, an increase in target cost can be suppressed.

It is possible to use the vessel with its interior at any temperature, and it is preferable to use the vessel with its interior at a temperature of 0° C. to 100° C., and more preferable to use the vessel with its interior at room temperature for mass synthesis and cost reduction.

A nitrogen gas, an inert gas, a hydrogen gas, a CO₂ gas, or the like is introduced into the interior of the vessel singly or in combination to obtain the above-described atmosphere. From the viewpoint of cost, a nitrogen gas and an Ar gas are preferable.

These gases flow through the reaction vessel, and a produced substance can be recovered from the flow of the gases. Any flow rate of an atmosphere gas can be used, and a range of 0.5 L/min to 100 L/min is preferable and appropriate. In the evaporation process of the target, the gas flow rate is controlled to be constant.

The carbon nanohorn aggregate mixture is usually obtained, through the above-described reaction, as a carbon mixture of fibrous carbon nanohorn aggregates, spherical carbon nanohorn aggregates with a diameter of about 30 nm to 200 nm and a substantially uniform size, graphite with a size of 1 μm to several tens of μm, and carbon fragments.

### Removal of Catalyst

Catalytic metals contained during the production of the carbon nanohorn aggregate mixture may be removed as needed. The catalytic metals can be removed because these are dissolved in nitric acid, sulfuric acid, or hydrochloric acid. The hydrochloric acid is suitable from the viewpoint of ease of use. The temperature at which the catalyst is dissolved may be appropriately selected, and in a case of sufficiently removing the catalyst, it is desirable that the catalyst is heated to a temperature equal to or higher than 70° C. The removal timing of the catalyst is not particularly limited, and for example, in a case of using the nitric acid or the sulfuric acid, the removal of the catalyst and the production of defects (formation of hole-openings) described later can be performed concurrently or continuously. It is desirable to perform pretreatment in order to remove a carbon coating because the catalyst may be covered with the carbon coating when the carbon nanohorn aggregate mixture is produced. The pretreatment is desirably performed in air at about 250° C. to 450° C. Hole-openings may be partially formed at a temperature equal to or higher than 300° C.

### Removal of Graphite

Graphite can be removed from the carbon mixture obtained by the above-described laser ablation method or the like as necessary. Specifically, the carbon mixture is dispersed in an organic solvent, and graphite is precipitated and separated. When the carbon mixture is dispersed in the organic solvent, the graphite is precipitated. On the other hand, the fibrous carbon nanohorn aggregates and the spherical carbon nanohorn aggregates float due to low density. By recovering the supernatant of the dispersion together with the suspended solid content, the graphite and the carbon nanohorn aggregate (fibrous carbon nanohorn aggregate and spherical carbon nanohorn aggregate) can be separated. For further treatment in other steps, the solvent is preferably removed from the recovered supernatant. The method for removing the solvent is not particularly limited, and for example, the solvent may be removed by heat.

The organic solvent preferably has a density lower than that of graphite. The density of the organic solvent is preferably less than 1 g/cm³, and more preferably less than 0.8 g/cm³. Examples of such an organic solvent include ethanol and 2-propanol. In a solvent having a relatively high density such as an aqueous solvent, it is difficult to separate graphite. The dispersion can be prepared by, for example, ultrasonic dispersion. When only graphite is precipitated by leaving the obtained dispersion to stand or centrifugally separating the obtained dispersion, and the suspended solid content is recovered from the dispersion, a carbon nanohorn aggregate mixture from which the graphite has been removed is obtained.

As described above, the fibrous carbon nanohorn aggregates may be subjected to the production of defects, the modification with a functional group, and/or bonding with a compound.

A method for preparing the fibrous carbon nanohorn aggregates that can be used in the present example embodiment and that has defects, a desired functional group, or a desired compound will be described below. In one example embodiment, the introduction reaction of the defects, functional group, or compound can be performed on a mixture of the fibrous carbon nanohorn aggregates and the spherical carbon nanohorn aggregates.

### Production of Defects and Functionalization Step

Since the horn portions of the fibrous carbon nanohorn aggregate contain a large number of five-membered rings or seven-membered rings, slight defects can be produced on the horn surfaces without deteriorating the electrically conductive characteristics by using an oxidation treatment or the like. The method for performing such an oxidation treatment is not particularly limited, and either a gas phase process or a liquid phase process may be used.

As for the gas phase process, the oxidation treatment is performed in an atmosphere of a gas such as oxygen, air, hydrogen peroxide, carbon dioxide, or carbon monoxide. The oxidation treatment temperature under a gas atmosphere is preferably 250° C. to 650° C., more preferably 300° C. to 500° C., and still more preferably 300° C. to 400° C. This is because oxidation hardly occurs in a case where the temperature is too low, and oxidation is too fast and control is difficult in a case where the temperature is too high. The treatment time may be appropriately adjusted, and is preferably within a range of about 5 hours to 7 hours at a temperature rising rate of 1° C./min.

As for the liquid phase process, the oxidation treatment is performed in a liquid containing an oxidizing substance such as nitric acid, sulfuric acid, a sulfuric acid-nitric acid mixed solution, hydrogen peroxide, or chloric acid. The oxidation treatment with these acids is performed at a temperature of about 0° C. to 180° C. in a case of using an aqueous solution system (the temperature is sufficient to be a temperature at which an aqueous solution exists as a liquid), or at a temperature at which a solvent to be used exists as a liquid in a case of using an organic solvent system. As for the nitric acid or the sulfuric acid, the temperature range is preferably from room temperature to 120° C. The hydrogen peroxide may be used within a temperature range of room temperature to 100° C., and the temperature range is more preferably equal to or higher than 40° C. The oxidizing power efficiently acts within a temperature range of 40° C. to 100° C. In particular, a temperature range of 50° C. to 80° C. is preferable. The treatment time may be appropriately adjusted, and is preferably within a range of about 0.5 hours to 3 hours. In the liquid phase process, it is more effective to use light emission in combination.

By the above-described oxidation treatment, it is possible to add a functional group such as a carbonyl group, a carboxyl group, a hydroxyl group, a nitro group, a sulfone group, a phenol group, an oxygen-containing functional group containing an ether bond or an ester bond, or an imino group to a 5-membered ring or a 7-membered ring at which a graphite surface is curved, such as a tip of a carbon nanohorn, or other highly reactive carbon sites.

In one example embodiment, it is preferable to carry out weak oxidation treatment and to avoid excessive oxidation. This is because, although oxidation is initiated at a highly reactive 5-membered ring or 7-membered ring that is present in a large amount at the tip portion by the oxidation treatment, excessive oxidation treatment may cause over-oxidation, leading to the removal of nanohorn tips, and as a result, capping with cyclodextrin described later is no longer possible or a nanohorn body may also be oxidized to generate pores, thereby causing changes in bulk properties of the carbon nanohorn aggregate.

The degree of the oxidation in this case is preferably set to such a degree that oxygen is contained at a ratio of preferably 1.0×10⁻⁵% by atomic fraction to 1.0×10⁰% by atomic fraction, more preferably 1.0×10⁻³% by atomic fraction to 1.0×10⁰% by atomic fraction with respect to the total carbon (100% by atomic fraction). Although various analysis methods may be used, the ratio of oxygen to carbon may be estimated from, for example, an intensity ratio of O1s to C1s obtained by X-ray photoelectron spectroscopy.

### Cyclodextrin Treatment

By bonding a compound that enhances adhesiveness to the base material to the fibrous carbon nanohorn aggregate, the adhesiveness of the fibrous carbon nanohorn aggregate to the base material can be further enhanced. Examples of such a compound include cyclodextrin.

By treating the carbon nanohorn aggregate mixture subjected to the above-described oxidation treatment with a cyclodextrin-containing solution, a hydrophilic carbon nanohorn aggregate mixture in which the nanohorn tip portions are capped with cyclodextrin can be produced. Since an oxygen-containing functional group is introduced at the tip portion of the carbon nanohorn aggregate, the tip portion interacts with an OH group of cyclodextrin, and specifically, forms hydrogen bonds, leading to the immobilization and stabilization of cyclodextrin.

Cyclodextrin (hereinafter, may be abbreviated as “CD”) is a cyclic oligosaccharide, is a non-reducing sugar in which glucose residues are linked by α-1,4 bonds to form a cyclic structure, and has a torus structure also called a bottomless bucket-structure or a crown-structure. The cyclodextrin has the hydrophobic interior, but is water-soluble because it has a large number of OH groups on the exterior.

Examples of the cyclodextrin include well-known cyclodextrins such as unsubstituted cyclodextrins containing 6 to 12 glucose units, depending on the difference in the number of constituting glucose units, particularly α-cyclodextrin, β-cyclodextrin, γ-cyclodextrin, and/or derivatives thereof, and/or mixtures thereof. α-Cyclodextrin is composed of 6 glucose units, β-cyclodextrin is composed of 7 glucose units, and γ-cyclodextrin is composed of 8 glucose units, each having a different cavity size from one another. In the present example embodiment, it is preferable to contain at least one selected from the group consisting of α-cyclodextrin, β-cyclodextrin, and γ-cyclodextrin.

In cyclodextrin treatment, an oxidation-treated carbon nanohorn aggregate mixture is brought into contact with cyclodextrin in a solution in which the cyclodextrin is dissolved. As the dispersion medium, a dispersion medium containing water or, in addition to water, a surfactant, a water-soluble organic solvent, and the like as necessary is used.

The addition amount of the cyclodextrin may be appropriately selected, and is, for example, 0.1 to 50 parts by mass and preferably 0.5 to 10 parts by mass with respect to 100 parts by mass of the carbon nanohorn aggregate mixture subjected to the oxidation treatment.

The treatment conditions are not particularly limited, and may be appropriately selected, for example, in a range of 0° C. to 100° C. and preferably in a range of 10° C. to 70° C. In one example embodiment, for example, a range of 15° C. to 60° C. close to room temperature is preferable. The treatment time may also be appropriately set, and for example, is equal to or longer than 10 minutes and preferably equal to or longer than 3 hours, and the upper limit is not particularly limited, and may be, for example, equal to or shorter than 10 days.

As described above, the oxygen-containing functional group at the tip portion of the carbon nanohorn aggregate and the hydroxyl group of the cyclodextrin interact with each other, and specifically, are immobilized through hydrogen bonding, to obtain a stabilized hydrophilic carbon nanohorn aggregate mixture. As a result of the hydrophilicity obtained, the dispersibility in an aqueous medium is improved.

The carbon nanohorn aggregate mixture that is obtained as described above and subjected to the production of defects on horn portions, the modification with a functional group that enhances adhesiveness to the base material, and/or the bonding with a compound that enhances adhesiveness to the base material exhibits high hydrophilicity. Therefore, in a case where the aforementioned carbon nanohorn aggregate mixture dispersion is prepared, there is also an advantage in that favorable dispersion in an aqueous dispersion medium is achieved without adding a surfactant, and monodispersion is facilitated.

In one example embodiment, the number of fibrous carbon nanohorn aggregates constituting the nanocarbon composite is preferably equal to or less than 1/10 of, and more preferably equal to or less than 1/20 of the number of carbon nanotubes, and is preferably equal to or more than 1/10⁵, more preferably equal to or more than 1/10⁴, more preferably equal to or more than 1/1000, and more preferably equal to or more than 1/100, but not limited thereto. The number of fibrous carbon nanohorn aggregates and carbon nanotubes can be measured by observing a scanning electron micrograph image (SEM image) of the nanocarbon composite. The visual field range is not limited, but is preferably about 1 μm to 10 μm in each of vertical and horizontal directions. In one example embodiment, the mass ratio of the fibrous carbon nanohorn aggregates constituting the nanocarbon composite is, for example, preferably equal to or more than 1% by mass and more preferably equal to or more than 10% by mass, and preferably equal to or less than 10,000% by mass and more preferably equal to or less than 1,000% by mass with respect to the mass of the carbon nanotubes. In a case where the content of the fibrous carbon nanohorn aggregates in the nanocarbon composite is too large, the probability of forming an electrically conductive path including the fibrous carbon nanohorn aggregates alone between electrodes increases, and the absolute value of the TCR may decrease. In a case where the content of the fibrous carbon nanohorn aggregate in the nanocarbon composite is too small, the resistance of the nanocarbon composite may not be sufficiently lowered.

### <Method for Producing Nanocarbon Composite>

A method for producing the nanocarbon composite will be described. In one example embodiment, the nanocarbon composite can be produced by preparing a first dispersion containing semiconducting carbon nanotubes and a second dispersion containing fibrous carbon nanohorn aggregates, and using these dispersions (method A). Alternatively, in one example embodiment, the nanocarbon composite can be produced by using a nanocarbon mixture dispersion in which semiconducting carbon nanotubes and fibrous carbon nanohorn aggregates are dispersed in the same dispersion medium (method B). In the present specification, the “dispersion medium” may be referred to as a “solvent”.

### (Method A)

In one example embodiment, a method for producing a nanocarbon composite includes:
a step (a) of preparing a first dispersion containing carbon nanotubes including (i) semiconducting carbon nanotubes in an amount equal to or more than 67% by mass with respect to a total amount of the carbon nanotubes and (ii) a first dispersion medium;
a step (b) of preparing a second dispersion containing fibrous carbon nanohorn aggregates and a second dispersion medium; and
a step (c) of applying the first dispersion and the second dispersion onto a base material. A concentration (number of aggregates/mL) of the fibrous carbon nanohorn aggregates in the second dispersion is equal to or less than one-tenth of a concentration (number of nanotubes/mL) of the carbon nanotubes in the first dispersion.

In the present specification, the term “applying” means that “adhering a liquid to a target object” or “allowing a liquid to be in contact with a target object”, and includes, for example, “adhering a liquid to a target object” or “allowing a liquid to be in contact with a target object” by a method of such as dropwise addition, spraying, aerosol spraying, spin-coating, rolling, printing such as inkjet, immersing, or applying with a brush or the like. The phrase “applying the dispersion onto the base material” means that the dispersion may be brought into direct contact with the base material, or the dispersion may be brought into contact with an applied product previously applied onto the base material.

### (Step (a): Preparation of Carbon Nanotube Dispersion)

In one example embodiment, a method for producing a nanocarbon composite includes a step (a) of preparing a carbon nanotube dispersion (also referred to as a “first dispersion” or a “semiconducting carbon nanotube dispersion”) containing (i) a plurality of carbon nanotubes including semiconducting carbon nanotubes in an amount equal to or more than 67% by mass with respect to a total amount of the carbon nanotubes and (ii) a first dispersion medium. In one example embodiment, it is preferable that the first dispersion further contains a surfactant, and the first dispersion medium contains an aqueous solvent (preferably water or heavy water). For the carbon nanotubes, the surfactant (preferably, nonionic surfactant), and the first dispersion medium in the first dispersion, the description described above in the separation of the semiconducting carbon nanotubes is applied. As the first dispersion medium, water, heavy water, an organic solvent, an ionic liquid, a mixture thereof, or the like can be used, but water or heavy water is preferable. As a preferred example embodiment, as described above, the first dispersion may be a carbon nanotube dispersion (semiconducting carbon nanotube dispersion) in which single-walled carbon nanotubes are dispersed with a nonionic surfactant and semiconducting carbon nanotubes obtained by an ELF method or the like are concentrated, or may be further concentrated, diluted, or the like.

The zeta potential of the first dispersion is preferably, but not limited to, +5 mV to −40 mV, more preferably +3 mV to −30 mV, and still more preferably +0 mV to −20 mV, for example. A value equal to or less than +5 mV is preferable because it means that the content of the metallic carbon nanotubes is small. In a case where the zeta potential is more than-40 mV, separation itself is fundamentally challenging. Here, the phrase “the zeta potential of the semiconducting carbon nanotube dispersion” means a zeta potential of a semiconducting carbon nanotube dispersion containing a nonionic surfactant and a semiconducting carbon nanotube micelles, which is obtained by, for example, the separation step using the ELF method. In the present specification, the zeta potential of the carbon nanotube dispersion is a value obtained by measuring the dispersion using an ELSZ apparatus (Otsuka Electronics Co., Ltd.).

In one example embodiment, the concentration of the carbon nanotubes in the first dispersion is not limited, and is preferably equal to or more than 0.1 μg/ml and more preferably equal to or more than 1 μg/ml, and is preferably equal to or less than 0.3 mg/ml and more preferably equal to or less than 0.1 mg/ml. The number of carbon nanotubes in the first dispersion is not limited, and is preferably equal to or more than 10¹¹ number of nanotubes/mL and more preferably equal to or more than 10¹² number of nanotubes/mL, and is preferably equal to or less than 1015 number of nanotubes/mL and more preferably equal to or less than 1014 number of nanotubes/mL. The concentration of carbon nanotubes in the dispersion can be calculated by comparison with a dispersion having a known concentration using, for example, UV measurement, and the number of carbon nanotubes can be calculated by measuring the length and thickness distribution of CNTs applied onto the base material using AFM or the like and from the distribution and concentration of CNTs in the dispersion.

In a case where the first dispersion contains a surfactant, the concentration of the surfactant in the first dispersion is not limited, and is preferably, for example, about the critical micelle concentration to 5% by mass, more preferably 0.001% by mass to 3% by mass, and more preferably 0.01% to 1% by mass in order to minimize re-agglomeration and the like after application.

### (Step (b): Preparation of Dispersion Containing Fibrous Carbon Nanohorn Aggregates)

In one example embodiment, a dispersion (also referred to as a “second dispersion”) containing the fibrous carbon nanohorn aggregates used for producing the nanocarbon material composite contains the fibrous carbon nanohorn aggregates and a second dispersion medium. For the fibrous carbon nanohorn aggregates in the second dispersion, the above description of the fibrous carbon nanohorn aggregates is applied.

The second dispersion may contain spherical carbon nanohorn aggregates, graphite, carbon fragments, and the like generated when the fibrous carbon nanohorn aggregates are produced. In one example embodiment, the second dispersion is preferably a carbon nanohorn aggregate dispersion containing fibrous carbon nanohorn aggregates and spherical carbon nanotubes, and more preferably a mixture containing, as main components, fibrous carbon nanohorn aggregates and spherical carbon nanohorn aggregates, with graphite and the like removed from a carbon mixture (in the carbon mixture, the total of CNB and CNHs is preferably equal to or more than 90% by mass, more preferably equal to or more than 95% by mass, and still more preferably equal to or more than 99% by mass, or may be 100% by mass).

The second dispersion medium may be an organic solvent, an aqueous solvent, or a mixed solvent of an organic solvent and an aqueous solvent, and is preferably an organic solvent in one example embodiment.

Examples of the organic solvent include ethanol and 2-propanol. In a case where an aqueous solvent is used, the second dispersion preferably further contains a surfactant. Examples of the aqueous solvent and the surfactant include those described in the description of the carbon nanotubes.

In a case where the fibrous carbon nanohorn aggregates are dispersed in a surfactant solution, the surfactant adheres to the periphery of the monodispersed fibrous carbon nanohorn aggregates to form micelles. In a case where the spherical carbon nanohorn aggregates are contained, the surfactant also adheres to the periphery of the spherical carbon nanohorn aggregates to form micelles. The fibrous carbon nanohorn aggregates and the spherical carbon nanohorn aggregates are dispersed in the surfactant solution, and almost nothing precipitates.

The surfactant is sufficient to be spread in a film shape on a carbon nanohorn aggregate in order to avoid the agglomeration of the carbon nanohorn aggregates. Examples of the surfactant include nonionic surfactants such as polyoxyethylene stearyl ether (Brij) and ionic surfactants such as sodium dodecyl sulfate (SDS), sodium dodecylbenzene sulfate (SDBS), sodium cholate (SC), and sodium deoxycholate (DOC). In one aspect, the surfactant is preferably a nonionic surfactant, and for example, a nonionic surfactant that can be used to disperse the above-described carbon nanotubes may be used.

The concentration of the surfactant may be appropriately set according to a compound and the like to be used, is generally equal to or higher than the critical micelle concentration, and preferably higher than the critical micelle concentration, and the concentration is preferably equal to or more than 0.001% by mass and more preferably equal to or more than 0.01% by mass, and is preferably equal to or less than 10% by mass and more preferably equal to or less than 5% by mass. In the present specification, the critical micelle concentration (CMC) refers to a concentration at which a surface tension is measured by varying the concentration of the aqueous surfactant solution using, for example, a surface tensiometer such as a Wilhelmy-type surface tensiometer at a constant temperature, with the concentration determined from the inflection point. In the present specification, the “critical micelle concentration” is a value at 25° C. under atmospheric pressure.

The content of the fibrous carbon nanohorn aggregates in the second dispersion is not limited, and is preferably equal to or more than 0.1 μg/ml and more preferably equal to or more than 1 μg/ml, and is preferably equal to or less than 10 mg/ml and more preferably equal to or less than 1 mg/ml. The number of fibrous carbon nanohorn aggregates in the second dispersion is not limited, and is preferably equal to or more than 10⁸ number of aggregates/mL and more preferably equal to or more than 10⁹ number of aggregates/mL, and is preferably equal to or less than 10¹² number of aggregates/mL and more preferably equal to or less than 10¹¹ number of aggregates/mL. The concentration (number) of CNBs in the dispersion can be calculated from the concentration of the carbon nanohorn aggregate mixture in the dispersion and the ratio of the spherical carbon nanohorn aggregates to the fibrous carbon nanohorn aggregates estimated from the SEM image. In one example embodiment, the total content of the spherical carbon nanohorn aggregates and the fibrous carbon nanohorn aggregates in the second dispersion (the content of the carbon nanohorn aggregate mixture) is not limited, and is preferably equal to or more than 1 μg/ml and more preferably equal to or more than 10 μg/ml, and is preferably equal to or less than 10 mg/ml and more preferably equal to or less than 1 mg/ml.

The second dispersion can be prepared by adding the fibrous carbon nanohorn aggregates (that may be the carbon nanohorn aggregate mixture) to a dispersion medium and dispersing the fibrous carbon nanohorn aggregates. In one example embodiment, in order to improve the dispersibility of the carbon nanohorn aggregates, it is preferable to perform ultrasonic treatment.

(Step (c): Applying First Dispersion and Second Dispersion onto Base Material)

In the step (c), the first dispersion (semiconducting carbon nanotube dispersion) prepared in the step (a) and the second dispersion (fibrous carbon nanohorn aggregate dispersion) prepared in the step (b) are applied onto the base material.

The order of applying the first dispersion and the second dispersion is not limited, and the second dispersion may be applied after the first dispersion is applied, the first dispersion may be applied after the second dispersion is applied, or the first dispersion and the second dispersion may be applied at the same time. A drying step described later may be included every time the dispersion is applied. For example, the first dispersion may be first applied onto the base material and dried, followed by applying the first dispersion and/or the second dispersion.

In one example embodiment, at least one of the step of applying the first dispersion or the step of applying the second dispersion may be performed a plurality of times. In one aspect, in a case where the dispersion is applied a plurality of times, it is preferable to apply the dispersion once and dry the solvent, followed by applying the next dispersion. In a case where the dispersion is applied a plurality of times, one dispersion may be repeatedly and continuously applied, or the first dispersion and the second dispersion may be alternately applied. The application method may be the same each time or may be different each time. In a case where the dispersion is applied a plurality of times, the compositions of the first dispersion and/or the second dispersion may be the same or different each time.

The first dispersion medium and the second dispersion medium may be the same as or different from each other. In the present example embodiment, a first solvent and a second solvent may be different from each other because the first dispersion and the second dispersion can be separately prepared, one of the first and second dispersions can be applied, followed by removal of the solvent thereof by drying, and thereafter, the other dispersion can be applied. In a case where the first dispersion and the second dispersion are applied at the same time, it is preferable that the first solvent and the second solvent are the same as each other, both are aqueous solvents, or both are organic solvents. In one example embodiment, in a case where the first dispersion and the second dispersion are sprayed in an aerosol state (details will be described later), the first solvent and the second solvent may be applied at the same time even in a case where the first solvent and the second solvent are different from each other because droplets are small (for example, also including a case where one of the first and second solvents is an aqueous solvent and the other solvent is an organic solvent).

In one aspect of the step (c), a step of applying the first dispersion containing an aqueous solvent onto the base material and drying the first dispersion, followed by applying the second dispersion containing an organic solvent.

The method for applying the dispersion onto the base material is not particularly limited, and examples thereof include dropwise addition, spin coating, printing, inkjet, spray coating, dip coating, aerosol spraying, and the like. From the viewpoint of reducing the production cost of the bolometer, the printing method may be preferable.

### (Aerosol Spray)

The preferred example embodiment of the step (c) includes applying the first dispersion and/or the second dispersion onto the base material by spraying the first dispersion and/or the second dispersion in an aerosol state. As a result, the carbon nanotubes and/or the CNBs can be applied onto the base material while maintaining a dispersed state without agglomeration.

In one aspect, it is preferable to spray at least the second dispersion in an aerosol state because the fibrous carbon nanohorn aggregates (CNB) monodispersed in the dispersion as illustrated in FIG. 3 can be sprayed while the monodispersed state is maintained. As a result, the CNB can be adsorbed to the carbon nanotube film (including the inside of the carbon nanotube film) in a monodispersed state, and is easily dispersed in the carbon nanotube network. In the present specification, the phrase the fibrous carbon nanohorn aggregates are “adsorbed in a monodispersed state” means that the fibrous carbon nanohorn aggregates are preferably separated into individual aggregates and adhered to the carbon nanotube (that is, a state where two or more fibrous carbon nanohorn aggregates are not agglomerated).

The size of individual droplets of aerosol is not particularly limited as long as a single droplet can contain the carbon nanotube or one fibrous carbon nanohorn aggregate, and the diameter of a discharge port of an aerosol spray device is preferably equal to or more than 0.1 μm, and more preferably equal to or more than 0.5 μm in order to minimize clogging of the discharge port by a dispersed substance. In a case where the diameter of the discharge port is equal to or more than 0.5 μm, a dispersed substance is less likely to be clogged in the discharge port.

The diameter of the aerosol droplets provided on the base material in an aerosol state is not limited, and is preferably equal to or more than 100 nm and more preferably equal to or more than 500 nm, and is preferably equal to or less than 100 μm, more preferably equal to or less than 50 μm, and still more preferably equal to or less than 10 μm. In a case where the aerosol droplet diameter is small, the number of carbon nanohorn aggregates contained in a single aerosol droplet is one or a few, so that the carbon nanohorn aggregates are provided on the base material in a dispersed state, and furthermore, the solvent of the aerosol droplet dries faster, resulting in reduction of the occurrence of agglomeration on the base material. The droplet diameter of aerosol can be measured as, for example, D50 in a particle size distribution obtained by using a laser diffraction particle size distribution measuring device.

The aerosol density is not particularly limited, and the aerosol density is preferably adjusted in such a way that the number of aerosol droplets per unit area when the aerosol droplets adhere to the base material is equal to or more than 104 droplets/mm² and preferably equal to or more than 105 droplets/mm², and from the viewpoint of maintaining monodispersion, the number of aerosol droplets is equal to or less than 108 droplets/mm² and preferably equal to or less than 107 droplets/mm².

The aerosol spray may be repeatedly or continuously carried out, and it is preferable that the next spray is carried out after the solvent of the aerosol droplets has dried on the base material to avoid agglomeration on the base material. Since the solvent drying rate is high as described above in a case where the aerosol droplet diameter is small, the time interval between repeated sprays can be shortened.

In one example embodiment, the aerosol droplets may be sprayed directly onto the base material, or may be carried by a gas stream at a constant speed to reach the substrate. The gas type of the gas stream is not particularly limited, and a gas that does not react with the carbon nanohorn aggregate, such as air, nitrogen, argon, and helium, is preferable. Since the solvent of the aerosol droplets is dried while being moved by the gas stream, the carbon nanohorn aggregates can be supplied to the base material when the droplets reach the base material in a state where the droplet diameter becomes smaller or in a state where the carbon nanohorn assembly is completely dried and monodispersed.

The installation direction of the base material when the aerosol droplets are sprayed, the direction in which the aerosol droplets are sprayed (spray direction), the spray angle (spreading angle of liquid ejected from a nozzle), and the like are not limited. For example, the flat surface of the base material may be in the horizontal direction, may be inclined with respect to the horizontal direction, or may be installed to be in the vertical direction. The angle formed by the plane of the base material and the spray direction of the droplets (for example, the axial direction of a nozzle of an atomizer) may be any of 90° (vertical) to 0° (horizontal). For example, aerosol droplets may be supplied from an upward direction to a downward direction (for example, the vertical direction) of the plane of the base material that is horizontally placed. Alternatively, for example, the aerosol droplets may be sprayed from the side (from the horizontal direction) while the base material is held upright with the plane thereof oriented vertically. The angle between the base material and the spray direction of the aerosol droplets is not limited, and the angle between the plane of the base material and the axial direction of a nozzle body of the atomizer may be any angle of 90° (vertical) to 0° (horizontal), and can be appropriately selected. The spray angle (spread angle of liquid ejected from a nozzle) when the aerosol droplets are sprayed is not limited, and may be, for example, about 30° to 160°, and preferably about 40° to 80°.

In one example embodiment, both the first dispersion and the second dispersion may be sprayed in an aerosol state onto the base material, or only one dispersion may be sprayed in an aerosol state. The first dispersion and the second dispersion may be sprayed alternately in an aerosol state, or may be sprayed at the same time. In one example embodiment, it is preferred to spray the first dispersion and dry the solvent, followed by spraying the second dispersion.

In one example embodiment, in a case of spraying the first dispersion and/or the second dispersion in an aerosol state, the carbon nanotubes and CNB may be more uniformly present upon by moving the discharge port of the aerosol spray device and/or by moving the base material. That is, the CNB can be more uniformly adsorbed to the carbon nanotube.

As described above, while the fibrous carbon nanohorn aggregates are being produced, spherical carbon nanohorns are also formed. Consequently, the second dispersion may contain spherical carbon nanohorn aggregates. In this case, the spherical carbon nanohorn aggregates have smaller areas of contact with the carbon nanotubes and the base material and a smaller adhesion force than the fibrous carbon nanohorn aggregates. Therefore, the spherical carbon nanohorn aggregates may be shaken off through gaps of the carbon nanotube network in the washing step with a solvent or the like described later. On the other hand, since the CNBs have large contact areas with the carbon nanotubes and the base material due to their shape, and have strong adhesion force, the CNBs have a high probability of being adsorbed to the carbon nanotubes, and contributes to the effect of improving electrical conductivity.

### (Additional Step)

The step (c) may further include additional steps such as a washing step, a drying step, and a heat treatment step.

### Washing Step

The step (c) may include a step of washing with a solvent after applying the dispersion on the base material. Examples of such a solvent used in the washing step include water, ethanol, 2-propanol, and acetone.

As described above, for example, a CNT dispersion used for producing a CNT film may contain a surfactant for dispersing CNTs in water. In this case, it is presumed that the surfactant is highly likely to be present at a bonding point between the CNTs in the produced CNT film, and it is also considered that there is a problem in which electrically conductive paths at the bonding points are not sufficiently formed. However, in the step (c), the surfactant can be removed as follows.

In one example embodiment, in a case where the dispersion contains a surfactant, the micelle structure of the surfactant disintegrates when the dispersion is applied onto the base material and then washed with an organic solvent such as ethanol or 2-propanol. The surfactant can be removed by subsequently washing with water. In a case where the surfactant is removed, the carbon nanotubes and the fibrous carbon nanohorn aggregates are easily bonded directly, and the effect of imparting electrical conductivity to the fibrous carbon nanohorn aggregates can be more effectively exhibited.

For example, in a case where the first dispersion contains a surfactant and water as the first dispersion medium, the carbon nanotubes are covered with the surfactant to form micelles in the water. In a case where such a first dispersion is applied onto the base material, and the second dispersion containing an organic solvent (such as ethanol or isopropanol) as the second dispersion medium is then applied, the micelle structure existing around the carbon nanotubes disintegrates. As a result, it is easy to directly bond the semiconducting carbon nanotubes and the fibrous carbon nanohorn aggregates without interposing the surfactant therebetween, and the electrical conductivity of the fibrous carbon nanohorn aggregates can be utilized more effectively. The effect of removing the surfactant is further improved by applying this second dispersion and then washing with water. It is also preferable to move the base material in the washing step (preferably the washing step with water). In a case where the micelle structure of the surfactant disintegrates by the organic solvent to remove the surfactant as described above, the step of removing the surfactant by the heat treatment step described later can be shortened, omitted, or carried out at a lower temperature, or more complete removal of the surfactant can be achieved.

### Drying Step

The step (c) may include a drying step of removing the solvent of the applied dispersion. In the drying step, although not limited, for example, the applied dispersion may be heated at about 80° C. to 100° C., for example, a centrifugal force may be applied to the applied dispersion, or the applied dispersion may be placed under reduced pressure or left in the atmosphere. In a preferred example embodiment, the drying step is preferably carried out after applying one dispersion and before applying another dispersion. For example, it is preferable to apply the first dispersion, then apply a centrifugal force to remove the solvent, and subsequently apply the second dispersion. Both the washing step and the drying step described above may be carried out, and the order thereof is not limited, but it is preferable to carry out the drying step immediately after the washing step. In one example embodiment, in a case where the dispersion is applied by aerosol spraying, it is preferable to carry out the washing step after the drying step.

### Heat Treatment Step

The step (c) may include a heat treatment step of heating the applied dispersion at a temperature higher than that in the drying step. By employing the heat treatment step, the surfactant can be removed in addition to the removal of the solvent in a case where the dispersion contains a surfactant. The temperature of the heat treatment may be appropriately set to be equal to or higher than the decomposition temperature of the surfactant, and is preferably 150° C. to 500° C., more preferably 160° C. to 500° C., still more preferably 180° C. to 400° C., and even still more preferably 200° C. to 400° C. By setting the heat treatment temperature within the above range, it is easy to minimize the remaining of a decomposition product of the surfactant, and it is possible to inhibit the deterioration of the substrate. It is also possible to suppress the decomposition or size change of the carbon nanotubes, the detachment of the functional group, and the like. The heat treatment time is not limited, and can be set to, for example, 30 minutes to 300 minutes.

In one example embodiment, the carbon nanohorn aggregates contained in the second dispersion can be subjected to heat treatment in a non-oxidizing atmosphere such as an inert gas, hydrogen, or vacuum to improve its crystallinity. The heat treatment temperature in this case can be 800° C. to 2,000° C., and is preferably 1,000° C. to 1,500° C.

In one example embodiment, as necessary, the functional groups introduced into the defects of the carbon nanohorn aggregates can also be removed by heat treatment. The heat treatment temperature in this case may be 150° C. to 2000° C. In order to remove carboxyl groups, hydroxyl groups, and the like, 150° C. to 600° C. is desirable. As for carbonyl groups and the like, it is desirable to employ a temperature that is equal to or higher than 600° C.

The heat treatment step may be carried out after the application of all the dispersions onto the substrate is completed, but is not limited thereto.

### (Base Material)

A base material used for producing the above-described nanocarbon composite is not particularly limited, and for example, any of substrate or film may be used. In a case where the nanocarbon composite is used for a bolometer, the nanocarbon composite may be used as a substrate of the bolometer. In a case where the nanocarbon composite is used as the substrate of the bolometer, at least an element forming surface having insulating properties, an element forming surface having semiconducting properties, or the like may be used, and an element forming surface having insulating properties is particularly preferable.

The materials of the substrate and film as the base material are not particularly limited, and examples thereof include inorganic materials such as Si, SiO₂-coated Si, SiO₂, SiN, glass, and metals such as silver, gold, titanium, and aluminum, and organic materials such as parylene, polyimide, polyethylene, polypropylene, polystyrene, polyvinyl chloride, polyethylene terephthalate, an acrylonitrile styrene resin, an acrylonitrile butadiene styrene resin, a fluororesin, a methacrylic resin, and polycarbonate.

The base material may have an intermediate layer having a functional group that enhances adhesiveness with carbon nanotubes and/or fibrous carbon nanotubes.

The material of the intermediate layer is preferably a compound having both a partial structure adhering to the surface of the base material and a functional group having high adhesiveness to the carbon nanotube or the fibrous carbon nanohorn aggregate. Here, not only chemical bonding but also various intermolecular interactions such as electrostatic interaction, surface adsorption, hydrophobic interaction, van der Waals force, and hydrogen bonding may be used for adhesion between the fibrous carbon nanohorn aggregate and the functional group.

Examples of the partial structure adhering to the surface of the base material in the material of the intermediate layer include an alkoxysilyl group (SiOR), SiOH, and a hydrophobic moiety or hydrophobic group. Examples of the hydrophobic moiety or hydrophobic group include a methylene group (methylene chain) and an alkyl group, each having a carbon number equal to or more than one, preferably equal to or more than two, preferably equal to or less than 20, and more preferably equal to or less than 10.

Examples of the functional group having high adhesiveness to the fibrous carbon nanohorn aggregate in the material of the intermediate layer include amino groups such as a primary amino group (—NH₂), a secondary amino group (—NHR₁), and a tertiary amino group (—NR₁R₂), an ammonium group (—NH₄), a carboxy group (—COOH), a hydroxy group (—OH), a carbonyl group (—C(═O)—), an imino group (═NH), an imide group (—C(═O)—NH—C(═O)—), an amide group (—C(═O) NH—), a sulfo group (—SO₃H), a ferrocenyl group, an epoxy group, an isocyanurate group, an isocyanate group, a ureido group, a sulfide group, and a mercapto group.

The material of such an intermediate layer is not particularly limited, and examples thereof include a silane coupling agent. Examples of the silane coupling agent include
silane coupling agents (aminosilane compounds) having an amino group and an alkoxysilyl group, such as 3-aminopropyltrimethoxysilane, 3-aminopropylmethyltriethoxysilane, 3-aminopropylmethyltrimethoxysilane, 3-aminopropyltriethoxysilane (APTES), 3-(2-aminoethyl)aminopropyltrimethoxysilane, N-(2-aminoethyl)-3-aminopropyltrimethoxysilane, N-2-(aminoethyl)-3-aminopropylmethyltrimethoxysilane, and N-(2-aminoethyl)-3-aminopropylmethyldimethoxysilane;
silane coupling agents having an epoxy group and an alkoxysilyl group, such as 3-glycidoxypropyltrimethoxysilane, 3-glycidoxypropyltriethoxysilane, 3-glycidoxypropylmethyldimethoxysilane, 3-glycidoxypropylmethyldiethoxysilane, 2-(3,4-epoxycyclohexyl)ethyltrimethoxysilane, 3-glycidoxypropyldiethoxysilane, and triethoxy(3-glycidyloxypropyl)silane;
isocyanurate-based silane coupling agents such as tris-(trimethoxysilylpropyl) isocyanurate;
ureide-based silane coupling agents such as 3-ureidopropyltrialkoxysilane;
mercapto-based silane coupling agents such as 3-mercaptopropylmethyldimethoxysilane, 3-mercaptopropyltrimethoxysilane, and 3-mercaptopropyltriethoxysilane;
sulfide-based silane coupling agents such as bis(triethoxysilylpropyl)tetrasulfide; and
isocyanate-based silane coupling agents such as 3-isocyanate propyltriethoxysilane.

Silane coupling agents having an amino group (aminosilane compounds) are particularly preferable because of good bondability to the fibrous carbon nanohorn aggregate.

Other examples of the material of the intermediate layer include a polymer such as a cationic polymer, having a partial structure capable of adhering to a substrate and a partial structure capable of adhering to the fibrous carbon nanohorn aggregate, and a self-assembled monolayer (for example, thiol derivatives, phosphonic acid derivatives, and the like).

Examples of such a polymer include poly(N-methylvinylamine), polyvinylamine, polyallylamine, polyallyldimethylamine, polydiallylmethylamine, polydiallyldimethylammonium chloride, polydiallyldimethylammonium trifluoromethanesulfonate, polydiallyldimethylammonium nitrate, polydiallyldimethylammonium perchlorate, polyvinylpyridinium chloride, poly(2-vinylpyridine), poly(4-vinylpyridine), polyvinylimidazole, poly(4-aminomethylstyrene), poly(4-aminostyrene), polyvinyl(acrylamido-co-dimethylaminopropylacrylamide), polyvinyl(acrylamido-co-dimethylaminoethylmethacrylate), polyethyleneimine (PEI), DAB-Am and polyamidoamine dendrimers, polyaminoamide, polyhexamethylenebiguanide, polydimethylamine-epichlorohydrin, products of alkylation of polyethyleneimine with methyl chloride, products of alkylation of polyaminoamide by epichlorohydrin, cationic polyacrylamides using cationic monomers, formalin condensates of dicyandiamides, dicyandiamides, polyalkylene polyamine polycondensates, natural cationic polymers (for example, partially deacetylated chitin, chitosan, chitosan salts, and the like), synthetic polypeptides (for example, including, polyasparagine, polylysine, polyglutamine, and polyarginine).

Among such polymers, the cationic polymers having an amino group and a hydrophobic group or hydrophobic moiety are preferable from the viewpoint of adhesiveness to the fibrous carbon nanohorn aggregate. Examples of such cationic polymers include polylysine.

### (Method B)

In one example embodiment, a method for producing a nanocarbon composite includes:
a step of preparing a nanocarbon mixture dispersion formed by dispersing, in a dispersion medium, (i) a plurality of carbon nanotubes including semiconducting carbon nanotubes in an amount equal to or more than 67% by mass with respect to a total amount of the carbon nanotubes and (ii) fibrous carbon nanohorn aggregates; and
a step of applying the nanocarbon mixture dispersion onto a base material. The number of fibrous carbon nanohorn aggregates in the dispersion medium is preferably equal to or less than one-tenth of the number of the carbon nanotubes.

In the method B, a nanocarbon mixture dispersion in which carbon nanotubes and fibrous carbon nanohorn aggregates are dispersed in a single dispersion medium is prepared, and this nanocarbon mixture dispersion is applied onto a base material. The nanocarbon mixture dispersion may be prepared by adding semiconducting carbon nanotubes and fibrous carbon nanohorn aggregates to a dispersion medium (liquid), and mixing and dispersing the mixture with ultrasonic waves or the like. In one example embodiment, the nanocarbon mixture dispersion may be prepared by adding fibrous carbon nanohorn aggregates in a semiconducting carbon nanotube dispersion that contains carbon nanotubes including semiconducting carbon nanotubes in an amount equal to or more than 67% by mass with respect to the total amount of the carbon nanotubes, a surfactant, and water, and dispersing the mixture by ultrasonic waves or the like.

The description of the first dispersion medium and the second dispersion medium in the method A is applied to the dispersion medium used for the nanocarbon mixture dispersion. In the method B, since the carbon nanotubes and the fibrous carbon nanohorn aggregates are dispersed in the same dispersion medium, it is preferable to use a dispersion medium capable of dispersing both. In a case where an aqueous solvent is used as the dispersion medium, it is preferable to use the above-described surfactant (preferably, nonionic surfactant).

In one example embodiment, a nanocarbon mixture dispersion may be prepared by mixing a first dispersion and a second dispersion prepared by a method similar to the method A, and this nanocarbon mixture dispersion may be applied onto a base material. In this case, the first dispersion medium and the second dispersion medium are preferably compatible solvents, and more preferably the same solvents as each other.

### <Bolometer and Infrared Sensor>

One aspect of the present disclosure relates to a bolometer provided with a film containing the above-described nanocarbon composite, and an infrared sensor using the bolometer. FIG. 1 is a schematic view of the bolometer (preferably an infrared sensor detection unit) according to one example embodiment of the present invention. A first electrode 2 and a second electrode 4 are provided on a substrate 1, and these electrodes are connected by a nanocarbon composite film (also referred to as a “resistance variable film”) 3 disposed between the electrodes. In the present example embodiment, this nanocarbon composite film 3 preferably includes a carbon nanomaterial composite that contains a carbon nanotube film containing a plurality of carbon nanotubes forming an electrically conductive path electrically connecting the first electrode and the second electrode, and that contains fibrous carbon nanohorn aggregates adsorbed to the carbon nanotube film. The carbon nanotubes constituting the carbon nanotube film contains semiconducting carbon nanotubes in an amount equal to or more than 67% by mass (preferably equal to or more than 90% by mass) with respect to the total amount thereof. The length of CNB is preferably shorter than the inter-electrode distance between the first electrode 2 and the second electrode 4, leading to no direct connection of the electrodes by the fibrous carbon nanohorn aggregates.

The inventors of the present invention have found that containing fibrous carbon nanohorn aggregates in the resistance variable film that contains semiconducting carbon nanotubes in the bolometer enables a significant reduction of the resistance while maintaining a good TCR of the bolometer. This is considered to be because, as schematically illustrated in FIG. 2, in the nanocarbon composite film, the fibrous carbon nanohorn aggregates 22 exist in such a way as to connect the semiconducting carbon nanotubes 21 to each other.

The nanocarbon composite film is formed with the plurality of carbon nanotubes forming the electrically conductive path electrically connecting the first electrode and the second electrode and the fibrous carbon nanohorn aggregates. The plurality of carbon nanotubes may form, for example, a parallel linear, fibrous, or network structure, and it is preferable to form a network structure because agglomeration is less likely to be generated, and a uniform electrically conductive path can be obtained. In the present specification, the “nanocarbon composite film” may be described as a “nanocarbon composite layer”.

In the bolometer of the present disclosure, the inter-electrode distance is preferably 1 μm to 500 μm, and more preferably 5 to 200 μm for miniaturization. In a case where the thickness is equal to or more than 5 μm, deterioration of the characteristics of the TCR can be minimized even in a case where some metallic carbon nanotubes are contained. In a case where the thickness is equal to or less than 500 μm, it is advantageous for application of an image sensor by two-dimensional arraying.

In one aspect, in the plurality of carbon nanotubes connecting the first electrode and the second electrode, the number of carbon nanotubes between the electrodes (the number density of carbon nanotubes in the nanocarbon composite layer (3)) is preferably 1 nanotube/μm² to 1,000 nanotubes/μm², more preferably 10 nanotubes/μm² to 500 nanotubes/μm², and still more preferably 50 nanotubes/μm² to 300 nanotubes/μm². In one example embodiment, 10 nanotubes/μm² to 100 nanotubes/μm² is preferable in some cases. In a case where the number density is too small, it may be difficult to form electrically conductive paths. In a case where the number density is equal to or less than 1,000 nanotubes/μm², it is easy to minimize deterioration of the characteristics of the TCR even in a case where some metallic carbon nanotubes are contained. The number of carbon nanotubes can be calculated by, for example, measuring the number of carbon nanotubes per area using an AFM at random 10 points (each region of 1 μm×1 μm) on the carbon nanotube layer and averaging the measured number.

The thickness of the nanocarbon composite film that constitutes the resistance variable film of the bolometer is not limited, and may be preferably, for example, equal to or more than 1 nm, more preferably equal to or more than 2 nm, equal to or more than 3 nm, or equal to or more than 5 nm, and may be preferably equal to or less than 10 μm, more preferably equal to or less than 1 μm, or equal to or less than 200 nm. In one aspect, the thickness of the carbon nanotube film is preferably 2 nm to 1 μm, and more preferably 5 nm to 200 nm.

The bolometer in FIG. 1 detects temperature by utilizing temperature dependency of electric resistance caused by irradiation with light. Therefore, in other frequency regions, it can be similarly used in a case where the temperature changes due to irradiation with light, and for example, the terahertz region can also be detected. Variations in electric resistance due to temperature changes can be detected not only using the structure illustrated in FIG. 1 but also by amplifying resistance changes through providing a gate electrode to form a field-effect transistor.

### (Method for Producing Bolometer)

One example embodiment of the present disclosure relates to a method for producing a bolometer (preferably, a bolometer for an infrared sensor detection unit) having a resistance variable film containing the above-described nanocarbon composite. As described above, in one example embodiment, a bolometer includes a first electrode 2 and a second electrode 4 provided on a substrate 1, and these electrodes are connected by a nanocarbon composite film 3 disposed between the electrodes. The nanocarbon composite film 3 is mainly formed as the above-described nanocarbon composite. Such a bolometer can be manufactured, for example, but not limited to, as follows. The Si coated with SiO₂ as a substrate is sequentially washed with acetone, isopropyl alcohol, and water, and thereafter, organic substances and the like on a surface are removed by oxygen plasma treatment. The substrate is immersed in an aqueous solution of 3-aminopropyltriethoxysilane (APTES), then washed with water, and dried. A nanocarbon composite film is produced on this substrate by the method for producing a nanocarbon composite film described above. For example, first, a first dispersion containing semiconducting carbon nanotubes, a nonionic surfactant, and water, and a second dispersion containing fibrous carbon nanohorn aggregates and isopropanol are prepared. Next, while the substrate is rotated by spin coating, the first dispersion is sprayed in an aerosol state onto the substrate and then dried, and subsequently the second dispersion is sprayed in an aerosol state onto the substrate and then dried and washed with water (application step). This application step may be repeated. The nonionic surfactant and the like may be removed by firing at 200° C. in the atmosphere. By these operations, a thin film containing the nanocarbon composite is formed on the substrate. Thereafter, first and second electrodes are produced at an interval of 50 μm by gold vapor deposition on the thin film of the nanocarbon composite. An acrylic resin (PMMA) solution is applied to a region between electrodes on the formed thin layer of the nanocarbon composite to form a PMMA protective layer. Thereafter, the entire substrate is subjected to oxygen plasma treatment to remove excessive carbon nanotubes and the like in a region other than the nanocarbon composite film 3. Excess solvent, impurities, and the like are removed by heating at 200° C. in the atmosphere.

The first electrode and the second electrode on the substrate can be produced using, but not limited to, gold, platinum, titanium alone or a plurality thereof. A method for producing the electrode is not particularly limited, and examples thereof include vapor deposition, sputtering, and printing. The thickness can be appropriately adjusted, and is preferably 10 nm to 1 mm, and more preferably 50 nm to 1 μm. The dispersion may be applied to the substrate provided with the electrodes in advance, or the electrodes may be produced after the dispersion is applied, or before or after the heat treatment.

A protective film may be provided on the surface of the nanocarbon composite layer as necessary. The protective film preferably contains a material having high transparency in the infrared wavelength range to be detected. Examples thereof include acrylic resins such as PMMA and PMMA anisole, epoxy resins, and Teflon (registered trademark).

The infrared sensor according to the present example embodiment may be a single element, or may be an array in which a plurality of elements used for an image sensor are two-dimensionally arranged.

### EXAMPLES

Hereinbelow, the present invention will be described in more detail with reference to Examples, but the present invention is not limited to these Examples.

### Preparation Example 1: Separation of Semiconducting Carbon Nanotubes

### (Step a1)

Into a quartz boat, 100 mg of single-walled carbon nanotubes (EC1.0 (diameter: about 1.1 to 1.5 nm (average diameter of 1.2 nm) manufactured by Meijo Nano Carbon Co., Ltd.) was placed, and subjected to heat treatment using an electric furnace under a vacuum atmosphere. The heat treatment was carried out at a temperature of 900° C. for 2 hours. The weight after the heat treatment was reduced to 80 mg, and it was found that surface functional groups and impurities were removed. The obtained single-walled carbon nanotubes were crushed with tweezers, and then 12 mg of the single-walled carbon nanotubes were immersed in 40 ml of a 1% by weight surfactant (polyoxyethylene (100) stearyl ether) aqueous solution, the immersion was maintained sufficiently, and ultrasonic dispersion treatment (BRANSON ADVANCED-DIGITAL SONIFIER DEVICE (OUTPUT: 50 W)) was carried out for 3 hours. As a result, there was no carbon nanotube agglomeration in the solution. Thereafter, ultracentrifugation treatment was performed under the conditions of 50,000 rpm, 10° C., and 60 minutes. By this operation, the bundles, the residual catalyst, and the like were removed to obtain a carbon nanotube dispersion. The dispersion was applied onto a SiO₂ substrate, dried at 100° C., and then observed with an atomic force microscope (AFM). As a result, it was found that 70% of the single-walled carbon nanotubes have a length within a range of 500 nm to 1.5 μm, with an average length of approximately 800 nm.

### (Step a2)

The carbon nanotube dispersion obtained in the step a1 was introduced into a separator having a double tube structure. About 15 ml of water, about 70 ml of the carbon nanotube dispersion, and about 10 ml of a 2% by weight surfactant aqueous solution were placed into the outer tube of the double tube, and about 20 ml of a 2% by weight surfactant aqueous solution was also placed into the inner tube. Thereafter, a lid on the lower side of the inner tube was opened to form a three-layer structure with different surfactant concentrations. By applying a voltage of 200 V with the lower side of the inner tube as an anode and the upper side of the outer tube as a cathode, the semiconducting carbon nanotubes moved to the anode. On the other hand, the metallic carbon nanotubes moved to the cathode side. The separation of semiconducting and metallic carbon nanotubes was fully completed after about 80 hours from the start of the separation. The separation step was performed at room temperature (about 25° C.). As a result of recovering the semiconducting carbon nanotube dispersion moved to the anode and analyzing the recovered dispersion by light absorption spectrum, and it was found that the components of the metallic carbon nanotubes were removed. From the Raman spectrum, 99% by weight of the carbon nanotubes in the carbon nanotube dispersion moved to the anode were semiconducting carbon nanotubes. The single-walled carbon nanotubes had the most frequent diameter of about 1.2 nm (equal to or more than 70%) and an average diameter of 1.2 nm. From the optical absorption spectrum, the number concentration of carbon nanotubes was calculated to be about 5×10¹³ number of nanotubes/mL.

As a result of measuring the zeta potential of the obtained semiconducting carbon nanotube dispersion using an ELSZ apparatus (Otsuka Electronics Co., Ltd.), the zeta potential was approximately-10 mV.

### Preparation Example 2: Production of Fibrous Carbon Nanohorn Aggregates

In a chamber under a nitrogen atmosphere, a carbon target containing iron was subjected to CO₂ laser ablation to produce a carbon mixture containing CNB. Specifically, a graphite target containing 1% by weight of iron was rotated at 1.5 rpm and continuously irradiated with a CO₂ laser. The energy density of the CO₂ laser was 50 kW/cm². The temperature in the chamber was set to room temperature, and the flow rate of nitrogen supplied into the chamber was adjusted to 10 L/min. The pressure in the chamber was controlled to 933.254 to 1266.559 hPa (700 to 950 Torr).

The obtained carbon mixture was subjected to thermogravimetric analysis. The fibrous carbon nanohorn aggregates and the spherical carbon nanohorn aggregates burned at about 560° C., and the graphite burned at about 640° C. As a result of thermogravimetric analysis, it was found that the amount of the graphite in the carbon mixture was about 20% by weight.

### (Removal of Graphite)

The carbon mixture was ultrasonically dispersed in ethanol at a concentration of 0.1 mg/ml, and the dispersion was left to stand for one day to recover about 50% of the supernatant. The supernatant was dried in an oven at 150° C. to obtain a solvent-free carbon mixture from which the graphite had been removed. This carbon mixture was observed by SEM, and the graphite was not observed, and a large amount of spherical carbon nanohorn aggregates and a small amount of fibrous carbon nanohorn aggregates were observed. The fibrous carbon nanohorn aggregate had a diameter of about 30 to 100 nm and a length of about 0.2 μm to 10 μm. Most of the spherical carbon nanohorn aggregates had a substantially uniform size within a diameter range of about 30 to 200 nm. The carbon mixture thus obtained was used as a carbon nanohorn aggregate mixture in the present example.

The supernatant was diluted to a concentration of 0.01 mg/ml, and a particle size distribution was measured by a dynamic light scattering method using the diluted supernatant. As a result, size distributions in a region of 100 nm to 600 nm and a region of 8 μm to 10 μm were detected. Since only the spherical carbon nanohorn aggregates and the fibrous carbon nanohorn aggregates were observed from the SEM photograph in this sample, it was found that the region of 100 nm to 600 nm included the spherical carbon nanohorn aggregates, and the region of 8 to 10 μm included the fibrous carbon nanohorn aggregates.

From these size distribution regions, it was found that the spherical carbon nanohorn aggregates and the fibrous carbon nanohorn aggregates were almost monodispersed or dispersed as several agglomerations in ethanol.

The supernatant was added dropwise to the substrate, the dried product was observed with SEM, and the ratio between the fibrous carbon nanohorn aggregates and the spherical carbon nanohorn aggregates (CNB/CNHs ratio) was estimated to be 0.04.

From the concentration of the supernatant and the CNB/CNHs ratio estimated from SEM observation, the number concentration of the fibrous carbon nanohorn aggregates was calculated to be about 109 number of aggregates/mL.

### Example 1

The carbon nanotube dispersion (dispersion containing carbon nanotubes moved to the anode) containing 99% by weight of the semiconducting carbon nanotubes obtained in Preparation Example 1 was used as a carbon nanotube dispersion A (also simply referred to as a “dispersion A”). The concentration of carbon nanotubes in the dispersion A was 30 μg/mL (3×10¹³ number of nanotubes/mL). The dispersion in which the carbon nanohorn aggregate mixture containing CNB was dispersed in ethanol, which was obtained in Preparation Example 2, was used as a carbon nanohorn aggregate mixture dispersion B (also simply described as a “dispersion B”). The dispersion B contains a carbon nanohorn aggregate mixture containing CNB in ethanol at a concentration of 20 μg/mL (the number of CNBs was 10⁹ number of aggregates/mL).

### (Formation of Electrode)

The Si substrate containing SiO₂ formed on a surface thereof was subjected to oxygen plasma treatment, a photoresist was then applied thereto, and the electrodes were patterned in such a way that the distance between the electrodes was 100 μm. For the electrodes, by using E-gun deposition, both a first electrode and a second electrode were formed by depositing to a thickness of 5 nm of Ti and to a thickness of 100 nm of Au, followed by the lift-off of the resist.

### (Application of Dispersion)

An Si substrate with these electrodes was washed with isopropyl alcohol and water, treated with an oxygen plasma asher, immersed in an APTES aqueous solution (0.1% by volume), washed with water, and then dried to form an APTES intermediate layer.

(Step (c1))

While the Si substrate on which the APTES intermediate layer was formed was rotated by a spin coater (condition: 500 rpm), the prepared carbon nanotube dispersion A was aerosol-sprayed onto the substrate using a sprayer and dried. The D50 droplet diameter of the aerosol observed by a laser diffraction particle size distribution measuring device was 50 μm.

(Step (c2))

Subsequently, while the Si substrate on which the coating film of the above-described dispersion A was formed was rotated by a spin coater (condition: 2,000 rpm), the dispersion B containing the fibrous carbon nanohorn aggregates was aerosol-sprayed using a sprayer onto the carbon nanotube coating film formed by the dispersion A, and was left to stand for 5 seconds, and while the Si substrate was rotated by a spin coater (condition: 1,000 rpm), 50 mL of water was added dropwise onto the substrate, and the substrate was washed with water and then dried. The D50 droplet diameter of the aerosol observed by a laser diffraction particle size distribution measuring device was 50 μm.

Step (c1) and step (c2) were alternately performed on the Si substrate. Specifically, the steps of applying and drying the dispersion A, applying the dispersion B, washing with water, and drying were repeated 20 times in this order, and then drying was carried out at 110° C. Heating was performed at 200° C. in the atmosphere to remove the nonionic surfactant and the like, thereby obtaining a Si substrate 1 including the nanocarbon composite film.

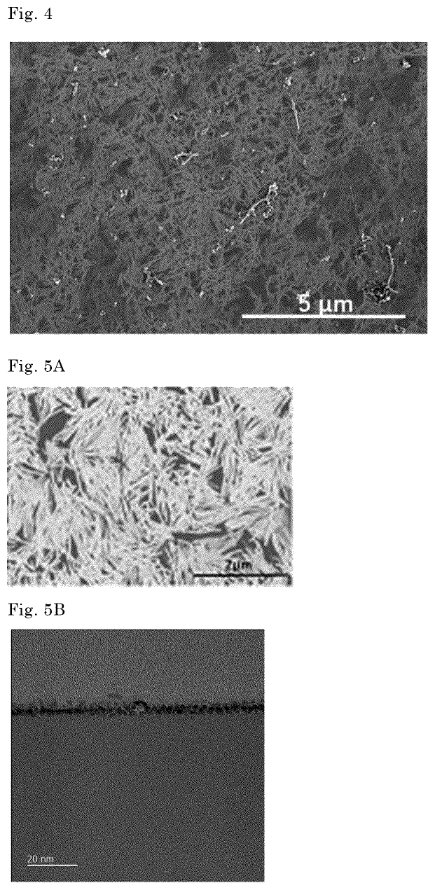

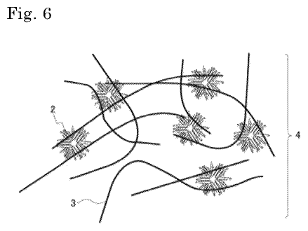

A surface SEM image of the obtained Si substrate is shown in FIG. 4. As shown in FIG. 4, it was observed that CNB was adhered in a monodispersed state onto the CNT network. It was also observed that 10 to 20 CNTs were connected to one CNB. From this result, it was found that by spraying the dispersion in an aerosol state, CNBs can be separated from each other, and a large number of CNTs can be adhered to CNB.

### (Production of Bolometer)

A PMMA anisole solution was applied between the electrodes on the obtained Si substrate 1 to protect the nanocarbon composite between the electrodes, and then subjected to oxygen plasma treatment to remove excess carbon nanotubes and the like in the vicinity of the electrodes. Thereafter, the resulting product was dried at 200° C. for 1 hour to obtain a bolometer 1.

The TCR value (dR/RdT) of the obtained bolometer 1 was −5%/K at 300 K, and the result of the film resistance value measured at a voltage of 3 V was 3.5×10⁶Ω.

### Comparative Example 1

### (Formation of Electrode)

The Si substrate containing SiO₂ formed on a surface thereof was subjected to oxygen plasma treatment, a photoresist was then applied thereto, and the electrodes were patterned in such a way that the distance between the electrodes was 100 μm. For the electrodes, by using E-gun deposition, both a first electrode and a second electrode were formed by depositing to a thickness of 5 nm of Ti and to a thickness of 100 nm of Au, followed by the lift-off of the resist.

An Si substrate with these electrodes was washed with isopropyl alcohol and water, treated with an oxygen plasma asher, immersed in an APTES aqueous solution (0.1% by volume), washed with water, and then dried to form an APTES intermediate layer. Onto the Si substrate, 100 μL of the dispersion A obtained in Preparation Example 1 was added dropwise, and the Si substrate was left to stand for 30 minutes. The Si substrate was washed with ethanol and water and dried at 110° C. Heating was performed at 200° C. in the atmosphere to remove the nonionic surfactant and the like, thereby obtaining a Si substrate 2 including the carbon nanotube film (without CNB).

A PMMA anisole solution was applied between the electrodes on the obtained Si substrate 2 to protect carbon nanotubes between the electrodes, and then excess carbon nanotubes and the like in the vicinity of the electrodes were removed by oxygen plasma treatment. Thereafter, the resulting product was dried at 200° C. for 1 hour to obtain a bolometer 2.

The TCR value (dR/RdT) of the obtained bolometer 2 was −5%/K at 300 K, and the film resistance value measurement result at a voltage of 3 V was 9.8×10⁹Ω.

The results of Example 1 and Comparative Example 1 demonstrated that the bolometer using the nanocarbon composite in the invention of the present application had a favorable TCR and a low resistance.

While the invention has been described with reference to example embodiments and examples thereof, the invention is not limited to these embodiments and examples. Various changes that can be understood by those of ordinary skill in the art may be made to form and details of the present invention without departing from the spirit and scope of the present invention.

### SUPPLEMENTARY NOTE

Some or all of the above example embodiments may be described as the following Supplementary Notes, but the disclosure of the present application is not limited to the following Supplementary Notes.

### Supplementary Note 1

A nanocarbon composite including
a plurality of carbon nanotubes including semiconducting carbon nanotubes in an amount equal to or more than 67% by mass with respect to a total amount of the plurality of carbon nanotubes, and
fibrous carbon nanohorn aggregates adsorbed to the carbon nanotubes, in which
the number of the fibrous carbon nanohorn aggregates is equal to or less than one-tenth of the number of the plurality of carbon nanotubes.

### Supplementary Note 2

A bolometer including
a substrate,
a first electrode disposed on the substrate,
a second electrode disposed on the substrate and spaced from the first electrode, and
a nanocarbon composite film electrically connected to the first electrode and the second electrode, in which
the nanocarbon composite film contains
a plurality of carbon nanotubes including semiconducting carbon nanotubes in an amount equal to or more than 90% by mass with respect to a total amount of the plurality of carbon nanotubes, and
fibrous carbon nanohorn aggregates adsorbed to the carbon nanotubes, and
the number of the fibrous carbon nanohorn aggregates is equal to or less than one-tenth of the number of the plurality of carbon nanotubes.

### Supplementary Note 3

The bolometer according to Supplementary Note 2, in which a length of each of the fibrous carbon nanohorn aggregates is shorter than an inter-electrode distance between the first electrode and the second electrode.

### Supplementary Note 4

A method for producing a nanocarbon composite, the method including
(a) preparing a first dispersion containing (i) a plurality of carbon nanotubes including semiconducting carbon nanotubes in an amount equal to or more than 67% by mass with respect to a total amount of the plurality of carbon nanotubes and (ii) a first dispersion medium,
(b) preparing a second dispersion containing fibrous carbon nanohorn aggregates and a second dispersion medium, and
(c) applying the first dispersion and the second dispersion onto a base material, in which
a concentration (number of aggregates/mL) of the fibrous carbon nanohorn aggregates in the second dispersion is equal to or less than one-tenth of a concentration (number of nanotubes/mL) of the plurality of carbon nanotubes in the first dispersion.

### Supplementary Note 5

The method for producing a nanocarbon composite according to Supplementary Note 4, in which
the first dispersion medium is water or heavy water, and the first dispersion further contains a surfactant, and
the second dispersion medium is an organic solvent.

### Supplementary Note 6

The method for producing a nanocarbon composite according to Supplementary Note 4 or 5, in which the (c) includes applying the first dispersion onto the base material, followed by applying the second dispersion.

### Supplementary Note 7

The method for producing a nanocarbon composite according to any one of Supplementary Notes 4 to 6, the method further including washing with water after applying the first dispersion and the second dispersion in the (c).

### Supplementary Note 8

The method for producing a nanocarbon composite according to any one of Supplementary Notes 4 to 7, in which the (c) includes performing, a plurality of times, at least one of applying the first dispersion or applying the second dispersion.

### Supplementary Note 9

The method for producing a nanocarbon composite according to any one of Supplementary Notes 4 to 8, in which the (c) includes applying the first dispersion and/or the second dispersion onto the base material by spraying the first dispersion and/or the second dispersion in an aerosol state.

### Supplementary Note 10

A method for producing a bolometer, the method including
(a) preparing a first dispersion containing (i) a plurality of carbon nanotubes including semiconducting carbon nanotubes in an amount equal to or more than 90% by mass with respect to a total amount of the plurality of carbon nanotubes and (ii) a first dispersion medium,
(b) preparing a second dispersion containing fibrous carbon nanohorn aggregates and a second dispersion medium, and
(c) applying the first dispersion and the second dispersion onto a base material, in which
a concentration (number of aggregates/mL) of the fibrous carbon nanohorn aggregates in the second dispersion is equal to or less than one-tenth of a concentration (number of nanotubes/mL) of the plurality of carbon nanotubes in the first dispersion.

### Supplementary Note 11

The method for producing a nanocarbon composite according to any one of Supplementary Notes 4 to 9, in which in the (c), applying the first dispersion and applying the second dispersion are alternately performed.

### Supplementary Note 12

The method for producing a nanocarbon composite according to Supplementary Note 9, in which the base material is moved while or after the first dispersion and/or the second dispersion is sprayed in an aerosol state.

### Supplementary Note 13

A method for producing a nanocarbon composite including:
preparing a nanocarbon mixture dispersion formed by dispersing, in a dispersion medium, (i) a plurality of carbon nanotubes including semiconducting carbon nanotubes in an amount equal to or more than 67% by mass with respect to a total amount of the plurality of carbon nanotubes and (ii) fibrous carbon nanohorn aggregates, and
applying the nanocarbon mixture dispersion onto a base material, in which
the number of the fibrous carbon nanohorn aggregates in the dispersion medium is equal to or less than one-tenth of the number of the plurality of carbon nanotubes.

### Supplementary Note 14

The method for producing a nanocarbon composite according to Supplementary Note 13, in which
the dispersion medium is water, and
the nanocarbon mixture dispersion further contains a surfactant.

### Supplementary Note 15

The method for producing a nanocarbon composite according to Supplementary Note 13 or 14, the method further including providing the nanocarbon mixture dispersion onto the base material by spraying the nanocarbon mixture dispersion in an aerosol state.

### Supplementary Note 16

The method for producing a bolometer according to Supplementary Note 10, in which
the first dispersion medium is water or heavy water, and the first dispersion further contains a surfactant, and
the second dispersion medium is an organic solvent.

### Supplementary Note 17

The method for producing a bolometer according to Supplementary Note 10 or 16, in which the (c) includes applying the first dispersion onto the base material, followed by applying the second dispersion.

### Supplementary Note 18

The method for producing a bolometer according to Supplementary Note 10, 16, or 17, the method further including washing with water after applying the first dispersion and the second dispersion in the (c).

### Supplementary Note 19

The method for producing a bolometer according to any one of Supplementary Notes 10, and 16 to 18, in which the (c) includes performing, a plurality of times, at least one of applying the first dispersion or applying the second dispersion.

### Supplementary Note 20

The method for producing a bolometer according to any one of Supplementary Notes 10 and 16 to 19, in which the (c) includes applying the first dispersion and/or the second dispersion onto the base material by spraying the first dispersion and/or the second dispersion in an aerosol state.

### Supplementary Note 21

The method for producing a bolometer according to any one of Supplementary Notes 10 and 16 to 20, in which in the (c), applying the first dispersion and applying the second dispersion are alternately performed.

### Supplementary Note 22

A method for producing a bolometer, the method including
applying a semiconducting carbon nanotube dispersion containing a surfactant, carbon nanotubes including semiconducting carbon nanotubes in an amount equal to or more than 90% by mass with respect to a total amount of the carbon nanotubes, and a dispersion medium onto a base material to form a carbon nanotube film,
applying an organic solvent onto the carbon nanotube film, and
washing with water after applying the organic solvent.

1. A method for producing a nanocarbon composite, the method comprising:
(a) preparing a first dispersion comprising (i) a plurality of carbon nanotubes comprising semiconducting carbon nanotubes in an amount equal to or more than 67% by mass with respect to a total amount of the plurality of carbon nanotubes and (ii) a first dispersion medium;
(b) preparing a second dispersion comprising fibrous carbon nanohorn aggregates and a second dispersion medium; and
(c) applying the first dispersion and the second dispersion onto a base material, wherein
a concentration (number of aggregates/mL) of the fibrous carbon nanohorn aggregates in the second dispersion is equal to or less than one-tenth of a concentration (number of nanotubes/mL) of the plurality of carbon nanotubes in the first dispersion.

5. The method for producing a nanocarbon composite according to claim 4, wherein
the first dispersion medium is water or heavy water, and the first dispersion further comprises a surfactant, and
the second dispersion medium is an organic solvent.

6. The method for producing a nanocarbon composite according to claim 4, wherein the (c) comprises applying the first dispersion onto the base material, followed by applying the second dispersion.

7. The method for producing a nanocarbon composite according to claim 4, the method further comprising washing with water after applying the first dispersion and the second dispersion in the (c).

8. The method for producing a nanocarbon composite according to claim 4, wherein the (c) comprises performing, a plurality of times, at least one of applying the first dispersion or applying the second dispersion.

9. The method for producing a nanocarbon composite according to claim 4, wherein the (c) comprises applying the first dispersion and/or the second dispersion onto the base material by spraying the first dispersion and/or the second dispersion in an aerosol state.

10. The method for producing a nanocarbon composite according to claim 5, wherein the (c) comprises applying the first dispersion onto the base material, followed by applying the second dispersion.

11. The method for producing a nanocarbon composite according to claim 5, the method further comprising washing with water after applying the first dispersion and the second dispersion in the (c).

12. The method for producing a nanocarbon composite according to claim 5, wherein the (c) comprises performing, a plurality of times, at least one of applying the first dispersion or applying the second dispersion.

13. The method for producing a nanocarbon composite according to claim 5, wherein the (c) comprises applying the first dispersion and/or the second dispersion onto the base material by spraying the first dispersion and/or the second dispersion in an aerosol state.

14. The method for producing a nanocarbon composite according to claim 8, wherein in the (c), applying the first dispersion and applying the second dispersion are alternately performed.

15. The method for producing a nanocarbon composite according to claim 9, wherein the base material is moved while or after the first dispersion and/or the second dispersion is sprayed in an aerosol state.
